(19) United States
(12) Patent Application Publication
(10) Pub. No.: US 2024/0109760 A1
(43) Pub. Date: Apr. 4, 2024

(54) REMOVABLE DECK FOR LIFT DEVICE

(71) Applicant: Oshkosh Corporation, Oshkosh, WI (US)

(72) Inventors: Zach Romain, Oshkosh, WI (US); William Nichols, Oshkosh, WI (US)

(73) Assignee: Oshkosh Corporation, Oshkosh, WI (US)

(21) Appl. No.: 18/375,609

(22) Filed: Oct. 2, 2023

Related U.S. Application Data
(60) Provisional application No. 63/412,958, filed on Oct. 4, 2022.
(60) Provisional application No. 63/526,728, filed on Jul. 14, 2023.

(51) Int. Cl. B66F 9/12

(52) U.S. Cl. CPC B66F 9/127; B66F 2700/123

(57) ABSTRACT

A deck for a lift device includes a floor that defines a surface, a pair of side portions, multiple wear pads, multiple pins, and a hand rail. The pair of side portions are positioned on opposite sides of the floor. Each of the pair of side portions is configured to define a channel configured to receive a middle rail of a platform of the lift device. At least one wear pad is positioned within each of the channels and abuts a top of the middle rail. The pins are removably inserted into openings of the side portions. The pins are configured to extend past a bottom surface of the middle rail to limit removal of the deck from the middle rail. The hand rail extends from a rear portion of the deck.

### CROSS-REFERENCE TO RELATED PATENT APPLICATIONS

This application claims the benefit of and priority to U.S. Provisional Application No. 63/412,958, filed Oct. 4, 2022, and U.S. Provisional No. 63/526,728, filed Jul. 14, 2023, the entire disclosures both of which are incorporated by reference herein in their entireties.

### BACKGROUND

The present disclosure relates lift devices. More specifically, the present disclosure relates to storage structure for lift devices.

### SUMMARY

One embodiment of the present disclosure is a deck for a lift device. The deck includes a floor that defines a surface, a pair of side portions, multiple wear pads, multiple pins, and a hand rail. The pair of side portions are positioned on opposite sides of the floor. Each of the pair of side portions is configured to define a channel configured to receive a middle rail of a platform of the lift device. At least one wear pad is positioned within each of the channels and abuts a top of the middle rail. The pins are removably inserted into openings of the side portions. The pins are configured to extend past a bottom surface of the middle rail to limit removal of the deck from the middle rail. The hand rail extends from a rear portion of the deck.

In some embodiments, the hand rail includes a pair of vertical members. The pair of vertical member are received within tubular members of the rear portion of the deck. The hand rail is adjustable between different heights relative to the tubular members.

The deck may also include a pin that is transitionable between an unlocked position so that the hand rail is translatable relative to the tubular members and a locked position so that the hand rail is limited in translation relative to the tubular members. In the locked position, the pin extends through openings of the tubular member and an opening of a vertical member of the hand rail.

In some embodiments, the side portions are configured to expose a top surface of a portion of the middle rail and portions of side surfaces of the middle rail such that a hook of a welding unit can couple with the middle rail along the portion of the middle rail that is exposed. The deck may further include a pair of hooks extending from a back of the rear portion. The pair of hooks are configured to couple with a portion of the middle rail to limit translation of the deck along middle rails of the lift device in a direction of the channels. The deck may be configured to support at least 250 pounds.

Another embodiment of the present disclosure is a deck for a lift device. The deck includes a floor, a pair of inner walls, a rear wall, and a pair of hooks. The floor defines a surface. The pair of inner walls are positioned on opposite sides of the floor. The rear wall is positioned between the pair of inner walls on a rear end of the floor. The pair of hooks extend from exterior surfaces of the pair of inner walls. The pair of hooks are configured to couple with middle rails of a platform of the lift device on opposite sides of the platform. The pair of hooks are adjustable between an upper position along the pair of inner walls and a lower position along the pair of inner walls in order to accommodate different models of lift devices to maintain a consistent height between a support surface of the platform and the floor of the deck.

In some embodiments, the pair of hooks are adjustable between the upper position and the lower position to accommodate platform assemblies of lift devices that have different rail heights. In some embodiments, one of the inner walls includes an inwards corner formed between the one of the inner walls and the rear wall to provide space for vertical rails of the platform of the lift device.

In some embodiments, the deck includes an open end opposite the rear wall between the pair of inner walls. The deck may further include a double-bent hook along an edge of the floor at the open end. The double-bent hook includes a first section extending downwards from the edge of the floor, and a second section extending substantially parallel with the floor in a direction beneath the floor towards the rear wall.

In some embodiments, the double-bent hook is sized to receive a rail of the platform of the lift device. The double-bent hook is configured to allow storage of the deck by hanging the deck on the rail of the platform.

In some embodiments, the deck includes a platform interface on a rear of the rear wall. The platform interface is configured to removably couple the deck with rails of the platform of the lift device.

In some embodiments, the platform interface includes a pair of hooks at an upper edge of the rear wall. The pair of hooks are disposed a distance apart along the rear wall and define slots having an open end that faces upwards. The hooks are configured to receive a bar of the platform through the open end to removably couple the deck with the platform.

In some embodiments, the platform interface further includes a curved member that protrudes from a bottom portion of the rear wall. The curved member is configured to be rotated into engagement with a horizontal rail as the bar of the platform is inserted into the slots of the hooks and rotated downwards.

Another embodiment of the present disclosure is a lift device. The lift device includes a base assembly, a lift assembly coupled with the base assembly, and a platform coupled with the lift assembly. The platform includes a base, multiple rales, and a removable deck. The removable deck includes a floor, a pair of inner walls, a rear wall and a pair of hooks. The floor defines a surface. The pair of inner walls are positioned on opposite sides of the floor. The rear wall extends between the pair of inner walls on a rear end of the floor. The pair of hooks extend from exterior surfaces of the pair of inner walls. The pair of hooks are configured to couple with middle rails of the platform of the lift device on opposite sides of the platform. The pair of hooks are adjustable between an upper position along the pair of inner walls and a lower position along the pair of inner walls in order to accommodate different models of lift devices to maintain a consistent height between a support surface of the platform and the floor of the removable deck.

In some embodiments, the pair of hooks are adjustable between the upper position and the lower position to accommodate platforms of lift devices that have different rail heights. One of the inner walls can include an inwards corner formed between the one of the inner walls and the rear wall to provide space for vertical rails of the platform of the lift device.

In some embodiments, the removable deck includes an open end opposite the rear wall between the pair of inner walls. The removable deck further includes a double-bent hook along an edge of the floor at the open end. The double-bent hook includes a first section extending downwards from the edge of the floor, and a second section extending substantially parallel with the floor in a direction beneath the floor towards the rear wall.

The double-bent hook is sized to receive a rail of the platform of the lift device. The double-bent hook is configured to allow storage of the removable deck by hanging the removable deck on the rail of the platform.

The removable deck may include a platform interface on a rear of the rear wall. The platform interface is configured to removably couple the removable deck with rails of the platform of the lift device. The platform interface includes a pair of hooks at an upper edge of the rear wall. The pair of hooks are disposed a distance apart along the rear wall and define slots having an open end that faces upwards. The hooks are configured to receive a bar of the platform through the open end to removably couple the removable deck with the platform. The platform interface can also include a curved member that protrudes from a bottom portion of the rear wall. The curved member is configured to be rotated into engagement with a horizontal rail as the bar of the platform is inserted into the slots of the hooks and rotated downwards.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a boom lift, according to some embodiments.

FIG. 2 is a perspective view of a platform of the boom lift of FIG. 1, according to some embodiments.

FIG. 3 is a perspective view of a platform of the boom lift of FIG. 1 including a removable deck, according to some embodiments.

FIG. 4 of a perspective view of the removable deck of FIG. 3 installed on the platform, according to some embodiments.

FIG. 5 is a perspective view of the removable deck of FIG. 3, according to some embodiments.

FIG. 6 is a perspective view of the removable deck of FIG. 3, according to some embodiments.

FIG. 7 is a perspective view of a portion of the removable deck of FIG. 3 installed on the platform, according to some embodiments.

FIG. 8 is a perspective view of a welding unit installed on the platform of FIG. 3, with the removable deck also installed on the platform, according to some embodiments.

FIG. 9 is a perspective view of the welding unit of FIG. 8 installed on the platform, with the removable deck also installed on the platform, according to some embodiments.

FIG. 10 is a top view of the welding unit of FIG. 8 installed on the platform, with the removable deck also installed on the platform, according to some embodiments.

FIG. 11 is a perspective view of a scissors lift, according to some embodiments.

FIG. 12 is a perspective view of a platform of the scissors lift of FIG. 11 including a removable deck.

FIG. 13 is a perspective view of the removable deck of FIG. 12, according to some embodiments.

FIG. 14 is a perspective view of a platform of a lift device, according to some embodiments.

FIG. 15 is a perspective view of a platform of a lift device, according to some embodiments.

FIG. 16 is a perspective view of a platform of a lift device, according to some embodiments.

FIG. 17 is a perspective view of a platform of a lift device, according to some embodiments.

FIG. 18 is a perspective view of a removable deck, according to some embodiments.

FIG. 19 is a perspective view of an extendable rail of the removable deck of FIG. 18 in a first position, according to some embodiments.

FIG. 20 is a perspective view of the extendable rail of FIG. 19 in a second position, according to some embodiments.

FIG. 21 is a perspective view of an extendable rail for the removable deck of FIG. 18, according to some embodiments.

FIG. 22 is a perspective view of a bracket for the extendable rail of FIGS. 19-21, according to some embodiments.

FIG. 23 is a perspective view of a portion of the removable deck of FIGS. 16-17, according to some embodiments.

FIG. 24 is a side view of a portion of the removable deck of FIG. 18 for installation on a platform having a first middle rail height, according to some embodiments.

FIG. 25 is a side view of a portion of the removable deck of FIG. 18 for installation on a platform having a second middle rail height, according to some embodiments.

FIG. 26 is a perspective view of a rear portion of the removable deck of FIG. 18, according to some embodiments.

FIG. 27 is a side view of the removable deck of FIG. 18 in a first position during installation, according to some embodiments.

FIG. 28 is a side view of the removable deck of FIG. 18 in a second position during installation, according to some embodiments.

FIG. 29 is a perspective view of the removable deck of FIG. 18 in a stowed position on a lift device platform, according to some embodiments.

FIG. 30 is a side view of the removable deck of FIG. 18, according to some embodiments.

FIG. 31 is a top view of the removable deck of FIG. 18 in various positions on a lift device platform, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the figures, a removable deck for a lift device (e.g., a scissors lift, a boom lift, etc.) includes a tray (e.g., a middle portion), side portions, a rear, and a hand rail. The hand rail is adjustably coupled with the rear of the removable deck such that the hand rail can be adjusted in height relative to the tray of the removable deck (e.g., between predetermined height positions). The side portions of the removable deck may define an inner volume or channel within which middle rails of a platform of the lift device are received. The removable deck includes pins that limit removal of the removable deck from the middle rails when installed. The removable deck also includes hooks that extend from the rear and couple with other portions of the middle rails. The side portions can couple with the middle rails while exposing portions of the middle rails so that equipment can be mounted on the middle rails without interference from the removable deck. Advantageously, the removable deck provides a surface for operators to store equipment or tools while working on the platform of the lift device.

### Lift Device and Platform

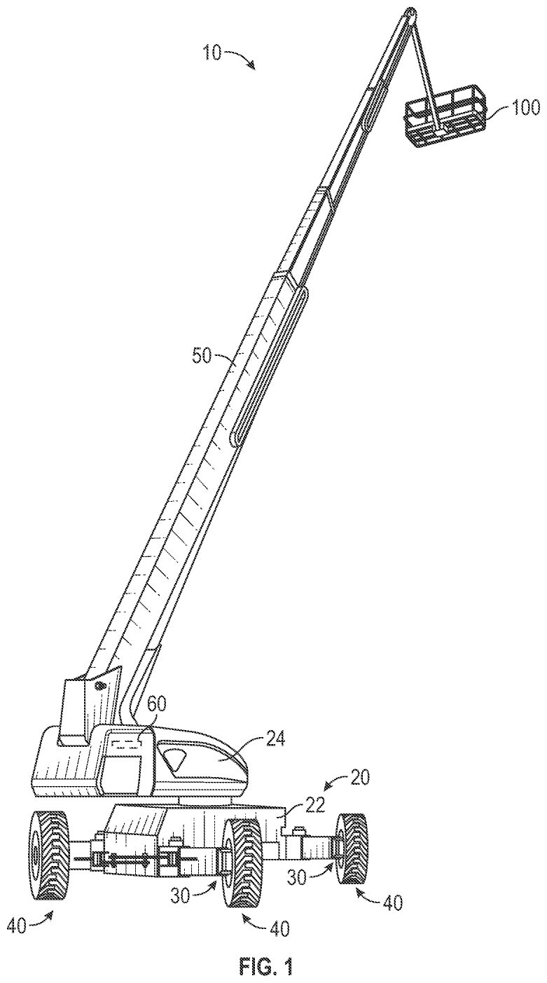

According to the exemplary embodiment shown in FIG. 1, a lift device, shown as lift device 10, includes a chassis, shown as chassis 20. According to an exemplary embodiment, the chassis 20 includes a frame, shown as frame 22. As shown in FIG. 1, the lift device includes a series of axles, shown as axles 30, coupled to the frame 22. In one embodiment, the lift device 10 includes a plurality of independent axles 30 (e.g., four, etc.) coupled to the frame 22. In another embodiment, the lift device 10 includes a first solid axle 30 coupled to a front end of the frame 22 and a second solid axle 30 coupled to a rear end of the frame 22. A wheel assembly (e.g., a wheel and tire assembly), shown as wheel assembly 40, is coupled to an end of each axle 30. The lift device 10 may include one or more actuators (e.g., hydraulic cylinders) to rotate the axles 30 relative to the frame 22 and/or to rotate the wheel assemblies 40 relative to the axles 30 (e.g., about respective vertical axes). This may facilitate varying the wheelbase of the lift device. The wheel assemblies 40 may include one or more actuators to drive the wheels and propel the lift device 10.

As shown in FIG. 1, the lift device 10 includes a lift assembly, shown as lift boom 50. In some embodiments, the lift boom 50 is rotatably coupled to the chassis 20. As shown in FIG. 1, the lift boom 50 is directly, pivotally coupled to a turntable 24 (e.g., such that the lift boom 50 rotates relative to the turntable 24 about a horizontal axis). The turntable 24 is rotatably coupled to the frame 22 (e.g., such that the lift boom 50 and the turntable 24 rotate relative to the frame 22 about a vertical axis). Rotation of the turntable 24 may be facilitated by a bearing disposed between the turntable 24 and the frame 22. As shown in FIG. 1, an operational device (e.g., an aerial work platform), shown as platform 100, is coupled to an end of the lift boom 50 opposite the frame 22.

Referring still to FIG. 1, the lift boom 50 includes a plurality of telescoping boom sections. An actuator may extend the plurality of telescoping boom sections to increase the extension length of the lift boom 50 (e.g., during operation of the lift device 10 by an operator aboard the platform 100, etc.). According to the exemplary embodiment shown in FIG. 1, the lift boom 50 is pivotally coupled to the turntable 24 such that the platform 100 may be elevated relative to a ground surface. In one embodiment, an actuator pivots the lift boom 50 upward, thereby increasing a working height of the platform 100.

As shown in FIG. 1, the lift device 10 includes a controller 60. The controller 60 is configured to facilitate various operations of the lift device 10. By way of example, the controller 60 may be configured to provide command signals relating to the rotation of the turntable 24 and the lift boom 50 relative to the frame 22, the extension of the lift boom 50, and the rotation of at least one of the wheel assemblies 40 (e.g., to drive the lift device 10, etc.). The controller 60 may also be configured to engage at least one actuator to facilitate movement of at least one of the wheel assemblies 40, the turntable 24, the lift boom 50, and the platform 100. By way of another example, the controller 60 may be communicably coupled with an operator input/output (I/O) device (e.g., a user interface) such that an operator of the lift device 10 may provide a variety of commands to the controller 60.

In other embodiments, the platform 100 is used with a different lift device or vehicle. By way of example, the platform 100 may be used with a boom lift, a scissor lift, a vertical lift, a telehandler outfitted with an operator platform, a crane, or another lift device. In yet other embodiments, the platform 100 is a fixed, stationary, or immobile platform, such as a catwalk, a scaffold, or a floor of a building.

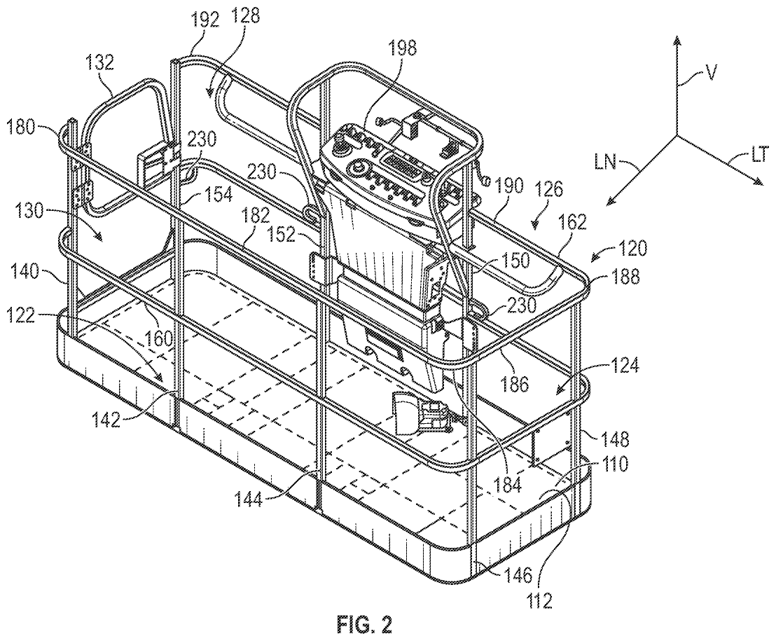

Referring to FIG. 2, the platform 100 is shown according to an exemplary embodiment. The platform 100 is configured to support an operator while elevated above the ground. The operator may perform one or more tasks while supported by the platform 100, or the operator may use the platform 100 to reach an elevated surface and subsequently exit the platform 100. A vertical axis V, a lateral axis LT, and a longitudinal axis LN are defined with respect to the platform.

The platform 100 includes a flat support surface, base, or platform, shown as base 110. A top surface of the base 110 (i.e., a support surface 112) is configured to support one or more operators. The support surface 112 may be a continuous, substantially flat surface, or the support surface 112 may include multiple sections that are separated from one another by one or more obstructions (e.g., a gap, a protrusion, etc.). By way of example, the base 110 may include one or more sheets of expanded metal.

The platform 100 further includes a hand railing, rail, handrail, handrail, guiderail, or boundary assembly, shown as handrail 120. The handrail 120 is configured to provide support for an operator and to prevent the operator from falling off of the platform 100. The handrail 120 is fixedly coupled to the base 110 and extends upward, above the support surface 112. The handrail 120 extends along a perimeter of the base 110. Specifically, as shown in FIG. 2, the handrail 120 includes a front portion 122 extending along a front side of the base 110, a right portion 124 extending along a right side of the base 110, and a rear portion 126 extending along the rear side of the base 110. As shown, the front portion 122, the right portion 124, and the rear portion 126 are continuous with one another. In other embodiments, the front portion 122, the right portion 124, and/or the rear portion 126 are (a) separated by one or more gaps, (b) made up of multiple sections, and/or (c) omitted. A volume, shown as working area 128, is defined between the base 110, the front portion 122, the right portion 124, and the rear portion 126. The working area 128 defines an area in which an operator can stand upon the base 110 while being contained within the handrail 120.

An aperture, gap, or opening, shown as doorway 130, is defined at the left side of the base 110 between the front portion 122 and the rear portion 126. A door or gate, shown as gate 132, selectively extends across the doorway 130 to prevent passage of the operator through the doorway 130. Specifically, the gate 132 is pivotally coupled to the front portion 122 (e.g., by a hinge) and selectively coupled to the rear portion 126 (e.g., by a latch).

The handrail 120 includes a series of upright members (e.g., members that are substantially vertical when the base 110 is level) and a series of horizontal members (e.g., members that are substantially horizontal when the base 110 is level). The upright members are approximately evenly spaced along the perimeter of the base 110 and fixedly coupled to the base 110. Specifically, proceeding counterclockwise as viewed from above, the handrail 120 includes the following upright members: upright member 140, upright member 142, upright member 144, upright member 146, upright member 148, upright member 150, upright member 152, and upright member 154. The handrail 120 includes a first horizontal member, shown as middle rail 160, and a second horizontal member or handrail, shown as top rail 162. The middle rail 160 is positioned between the top rail 162 and the base 110. The top rail 162 defines a top surface of the handrail 120. Each horizontal member or vertical member may include a single member or multiple members that are substantially aligned with one another. By way of example, the upright member 154 includes a single, continuous member, whereas the upright member 144 is bisected by the middle rail 160.

As shown, the top rail 162 includes a series of curved and straight sections that are arranged in a generally C-shape extending from the upright member 140 to the upright member 154. A first curved section 180 is coupled to a top end portion of the first upright member 140. A first straight section 182 extends in a lateral direction from the first curved section 180 to a second curved section 184. The first straight section 182 is coupled to top end portions of the upright member 142 and the upright member 144. A second straight section 186 extends between the second curved section 184 and a third curved section 188. The second straight section 186 is coupled to top end portions of the upright member 146 and the upright member 148. A third straight section 190 extends between the third curved section 188 and a fourth curved section 192. The third straight section 190 is formed in two parts, each part being coupled to a middle section of the upright member 150 or the upright member 152. The fourth curved section 192 is coupled to the upright member 154. As shown, each curved section is curved approximately 90 degrees.

The platform 100 provides a surface upon which operators stand while operating the lift device 10 with an I/O device 198. Specifically, the I/O device 198 is coupled to the handrail 120 between the upright member 150 and the upright member 152. The I/O device 198 faces inward such that it can be used by an operator standing within the working area 128. In one embodiment, the I/O device 198 is communicably coupled to various components of the lift device 10 (e.g., the wheel assemblies 40, the turntable 24, the lift boom 50, the platform 100, the controller 60, etc.) such that information or signals (e.g., command signals, etc.) may be exchanged to and from the I/0 device 198. By way of example, the I/O device 198 may include at least one of an interactive display, a touchscreen device, one or more buttons, joysticks, switches, and/or voice command receivers. An operator may use a joystick associated with the I/O device 198 to trigger the engagement of an actuator positioned to turn one of the wheel assemblies 40, thereby turning the lift device 10 towards a desired location. By way of another example, an operator may engage a lever associated with the I/O device 198 to trigger the extension or retraction of the plurality of sections of the lift boom 50.

### Removable Deck for Boom Lift

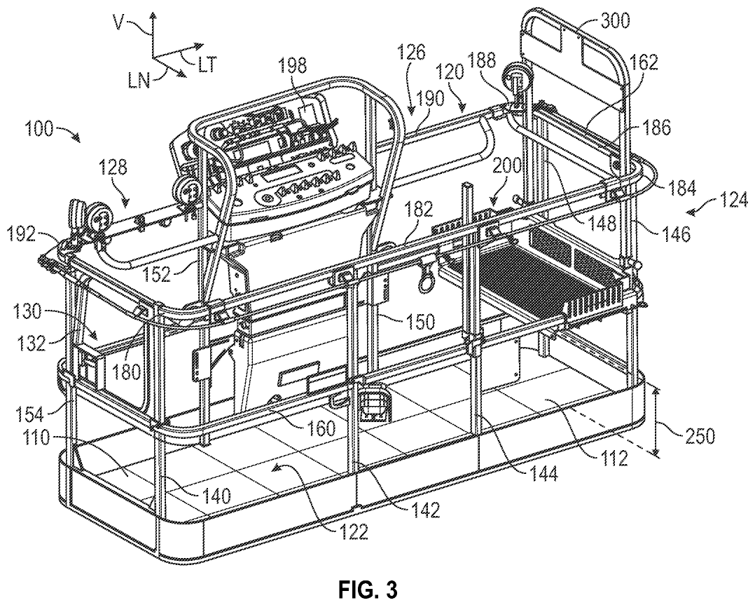

Referring to FIG. 3, the platform 100 includes a removable deck 200 (e.g., a supporting member, an elevated surface, a deck, etc.) that can be removably coupled (e.g., fixedly coupled, installed on, etc.) with the middle rail 160. The removable deck 200 is configured to provide a surface and structural support for equipment of an operator of the lift device 10. The removable deck 200 may be configured to be secured (e.g., removably fixedly coupled) on the platform 100 with the middle rails 160 at either lateral end of the platform 100. In some embodiments, the removable deck 200 may be removed from a first end of the platform 100 and reinstalled on an opposite end of the platform 100 (e.g., by an operator of the lift device 10). In some embodiments, the removable deck 200 has a load bearing capacity of 300 lbs.

The removable deck 200 extends between opposite longitudinal ends of the platform 100 (e.g., between the opposite middle rails 160 that extend laterally at different longitudinal positions). In some embodiments, the removable deck 200 removably couples with the middle rails 160 at opposite longitudinal sides or ends of the platform 100 and at a single lateral end of the platform 100.

The removable deck 200 includes a hand rail 300 (e.g., a rail, an elongated member, a tube, a tubular member, etc.) that extends from opposite longitudinal ends of the removable deck 200 in a vertical direction. The hand rail 300 may have an overall U-shape with ends that terminate proximate the opposite longitudinal ends of the removable deck 200. The hand rail 300 may extend vertically a distance past the top rail 162. The hand rail 300 can extend proximate the upright member 146 and the upright member 148 of the platform 100. The hand rail 300 includes vertical sections 302 (e.g., vertical portions, straight portions, etc.), curved sections 306 (e.g., corners) and a medial section 304. In some embodiments, the medial section 304 is positioned between the vertical sections 302 and is integrally formed with the vertical sections 302 and the curved sections 306. In some embodiments, the medial section 304 is perpendicular with the vertical sections 302. The hand rail 300 also includes a plate 308 that extends between the medial section 304, and the vertical sections 302.

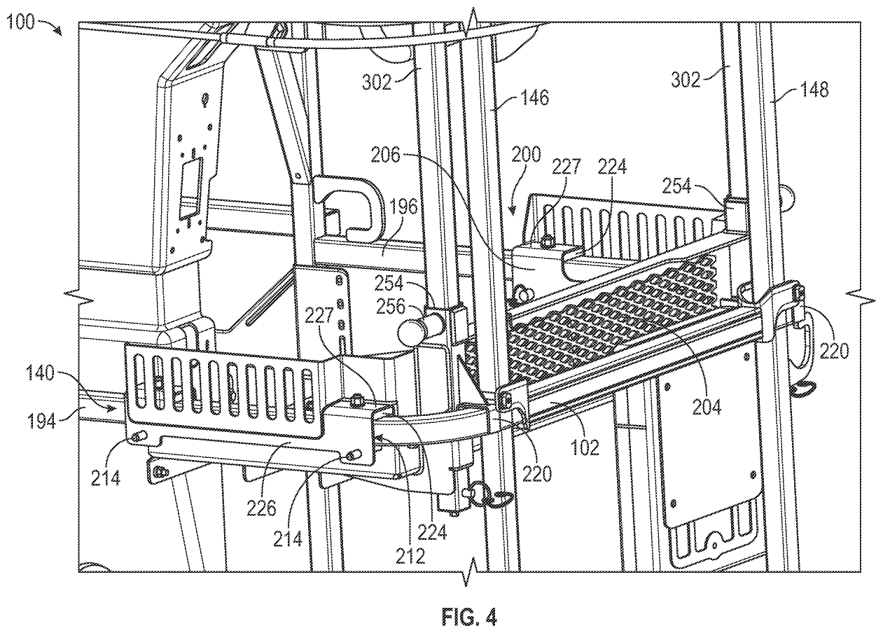

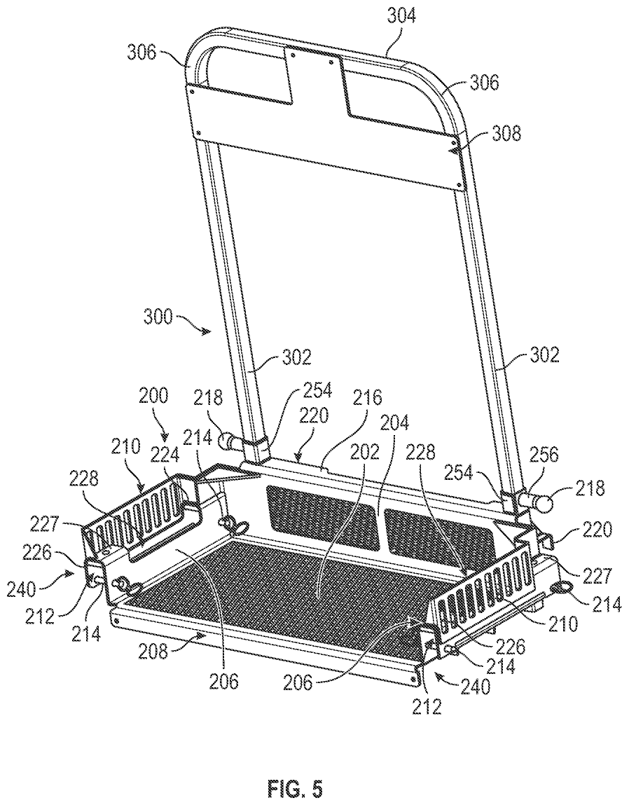

Referring to FIGS. 4-5, the removable deck 200 is configured to couple with a first portion 194 of the middle rail 160, a second portion 102 of the middle rail 160, and a third portion 196 of the middle rail 160. In some embodiments, the first portion 194, the second portion 102, and the third portion 196 of the middle rail 160 are integrally formed with each other. In some embodiments, the first portion 194 and the third portion 196 extend laterally and are offset from each other longitudinally. The second portion 102 extends laterally between the ends of the first portion 194 and the third portion 196.

The removable deck 200 includes a medial portion 202 (e.g., a surface, a perforated surface, a floor, a tray, etc.) that is configured to provide or define a face, surface, or area (e.g., a planar area, a support surface). The removable deck 200 also includes a back portion 204 (e.g., a back wall, a rear wall, etc.), and side portions 240 on opposite sides of the medial portion 202. The side portions 240, and the back portion 204 may be integrally formed with the medial portion 202 and extend vertically from the medial portion 202 (e.g., along the vertical axis or in the vertical direction). The back portion 204 may include an edge 216 that extends lengthwise along the back portion 204 (e.g., longitudinally) and is generally or substantially perpendicular with the back portion 204. The back portion 204 may define a rear wall. The back portion 204 may include one or more areas that have a perforated surface or openings that are covered with a mesh to facilitate weight reduction of the removable deck 200. In some embodiments, a weldment 208 extends downwards from an edge or lip of the medial portion 202 (e.g., opposite the back portion 204).

The side portions 240 may define side walls, side surfaces, inwards facing faces, etc., shown as inner walls 206. The inner walls 206 may face each other and extend vertically at opposite ends of the medial portion 202. In some embodiments, the side portions 240 include exterior surfaces, side walls, side surfaces, outwards facing faces, etc., shown as outer walls 226. In some embodiments, the outer walls 226 are substantially parallel with the inner walls 206. A web 227 (e.g., a surface, a connecting portion, etc.) extends between the outer walls 226 and the inner walls 206 of the side portions. The outer wall 226, the inner wall 206, and the web 227 may be integrally formed with each other and define a channel 212 that extends along an entire length of the side portions 240. The outer wall 226, the inner wall 206, and the web 227 may generally have a U-shape with an open end that is configured to receive the middle rail 160 (e.g., the first portion 194 and the third portion 196 of the middle rail 160).

Referring to FIG. 4, the first portion 194 and the third portion 196 of the middle rail 160 are shown received within the channels 212 of the side portions 140. The outer walls 226 and the inner walls 206 abut the middle rail 160 on opposite longitudinal ends of the middle rail 160, thereby limiting or restricting movement of the removable deck 200 relative to the middle rail 160 in the longitudinal direction or along the longitudinal axis. In some embodiments, the removable deck 200 includes wear pads 224 (e.g., bumpers, pads, compressible members, etc.) that are positioned within the channels 212 and coupled on an interior surface of the web 227. In some embodiments, the wear pads 224 are configured to abut, directly engage, contact, etc., a top surface of the middle rails 160. In some embodiments, the wear pads 224 are manufactured from a non-scratch material or a material that is softer than the material of the web 227. The wear pads 224 reduce a likelihood of the paint or coating of the middle rail 160 being chipped or scratched by the web 227. The engagement between the web 227 and the wear pads 224 limits or restricts movement of the removable deck 200 in a downwards vertical direction. In some embodiments, the removable deck 200 includes four wear pads 224.

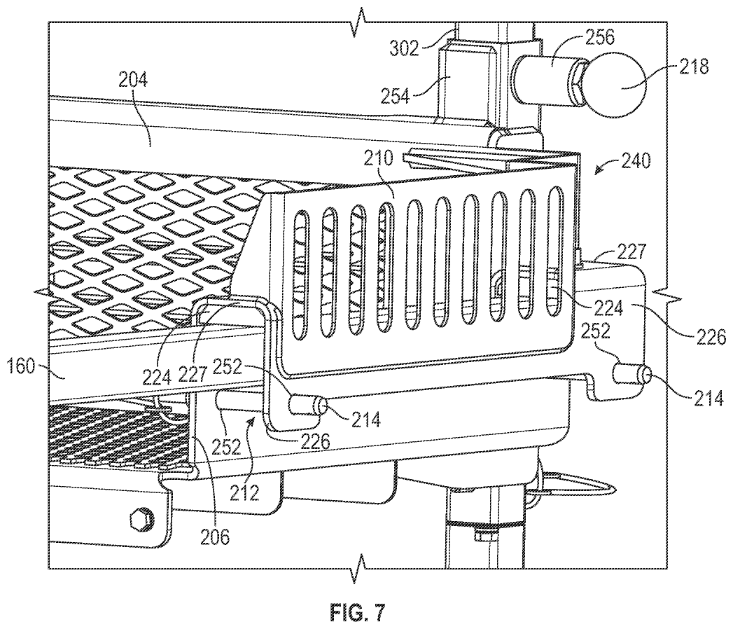

Referring particularly to FIGS. 4-7, the removable deck 200 includes multiple pins 214 (e.g., ball detent pins) that can be received by the inner walls 206 and the outer walls 226 through openings 252 (e.g., apertures, holes, openings, windows, etc.) of the inner walls 206 and the outer walls 226. In some embodiments, the openings 252 of the inner walls 206 and the outer walls 226 are aligned with each other. The openings 252 can be positioned below the webs 227 and the wear pads 224. In some embodiments, the pins 214 are removable or insertable into the openings 252. For example, the removable deck 200 may be installed on the middle rails 160 so that the middle rails 160 are positioned within the channels 212 and abut the wear pads 224. The pins 214 may be inserted into the openings 252 and extend across a width of the channel 212 between the outer walls 226 and the inner walls 206. Once installed (e.g., as shown in FIG. 7), the pins 214 limit or restrict movement of the removable deck 200 in the upwards vertical direction (e.g., upwards or towards the top rail 162). In some embodiments, the pins 214 limit removal of the removable deck 200 from the middle rail 160. In some embodiments, the pins 214 can be removed when an operator or user desires to remove the removable deck 200 from the middle rails 160. In some embodiments, the removable deck 200 includes four pins 214. In some embodiments, the pins 214 are configured to be inserted in a direction from the inner walls 206.

Referring particularly to FIGS. 5-7, the side portions 240 include an opening 228 (e.g., a window, a hole, a cutout, etc.) that is configured to expose portions of the middle rail 160 between the webs 227. In some embodiments, the opening 228 divides the webs 227 into two discrete portions, and the pins 214 and wear pads 224 are positioned at the discrete portions (e.g., the webs 227). The opening 228 extends along a part of a length of the side portion 240 and facilitates revealing or exposing the middle rail 160 so that the middle rail 160 is accessible to the operator or user. In some embodiments, the middle rail 160 is exposed between the webs 227 so that one or more attachments can be mounted on the middle rail 160 with the removable deck 200.

Referring to FIGS. 4-7, the removable deck 200 also includes side walls 210 (e.g., plates, walls, surfaces, faces, planar members, etc.) that extend vertically from the webs 227 and the outer walls 226. In some embodiments, the side walls 210 extend a height such that the side walls 210 terminate at a same height as a top of the back portion 204. In some embodiments, the side walls 210 include multiple openings 230 (e.g., elliptical openings, slots, etc.) that are disposed in an array along a length of the side walls 210. The side walls 210, the webs 227, and the inner walls 206 may define a step such that the side portions 240 of the removable deck 200 have a stepped shape.

Referring particularly to FIGS. 4-6, the removable deck 200 also includes a pair of tubular members 254 (e.g., tubes, hollow members, receiving members, etc.) that are integrally formed or otherwise fixedly coupled with the back portion 204. In some embodiments, the tubular members 254 are positioned at corners or ends of the back portion 204 at a transition between the back portion 204 and the side portions 240. In some embodiments, the tubular members 254 each have two open ends and are configured to receive the vertical sections 302 of the hand rail 300. In some embodiments, the tubular members 254 are positioned, disposed, or extend from a side of the back portion 204 opposite a side of the back portion 204 from which the medial portion 202 extends. In some embodiments, the tubular members 254 extend an entire vertical height of the back portion 204.

In some embodiments, the removable deck 200 includes a pair of hooks 220 (e.g., engagement portions, retention hooks, retention members, etc.) that extend from the back portion 204, or more specifically, from the tubular members 254. In some embodiments, the hooks 220 are integrally formed with the tubular members 254. In some embodiments, the hooks 220 are configured to hook, interface with, interlock with, extend at least partially around, etc., the second portion 102 of the middle rail 160. In some embodiments, the hooks 220 limit or restrict movement of the removable deck 200 along the middle rail 160 in the longitudinal direction (e.g., along the longitudinal axis, towards an opposite end of the platform 100, along the middle rail 160, etc.). In this way, the removable deck 200 may be translatably fixed relative to the platform 100 in multiple directions.

Referring particularly to FIGS. 4-7, the tubular members 254 include a tubular protrusion 256 that is configured to receive a spring release pin 218. In some embodiments, the tubular protrusion 256 has the form of an annular shoulder. In some embodiments, the tubular protrusion 256 includes an inner volume, a bore, a channel, an interior, etc., that is configured to receive a pin or elongated portion of the spring release pin 218. In some embodiments, a tensile or extension spring is positioned within the tubular protrusion 256 and is configured to bias the spring release pin 218 to translate along an axis 266 towards the tubular member 254. In some embodiments, the vertical sections 302 include openings 258 (e.g., bores, holes, through-holes, etc.) that are configured to align with the elongated portion of the spring release pin 218. The spring release pin 218 may be received within the openings 258 to lock, limit, or restrict translation of the hand rail 300 relative to the tubular members 254 and the removable deck 200. In some embodiments, the spring release pin 218 is transitionable between an unlocked position and a locked position. In the unlocked position, the elongated portion of the spring release pin 218 is not received within any openings 258 of the vertical section 302 so that the hand rail 300 can be translated (e.g., upwards or downwards) relative to the tubular members 254. In the locked position, the elongated portion of the spring release pin 218 is received within openings 258 of the vertical section 302 of the hand rail 300 so that the hand rail 300 is limited or restricted from translating (e.g., upwards or downwards) relative to the tubular members 254. In some embodiments, the spring of the spring release pin 218 is configured to bias the spring release pin 218 into the locked position. In some embodiments, the spring release pin 218 can be transitioned between the locked position and the unlocked position by manually pulling the spring release pin 218 away from the tubular member 254 or the hand rail 300 and twisting or rotating the spring release pin 218 about the axis 266.

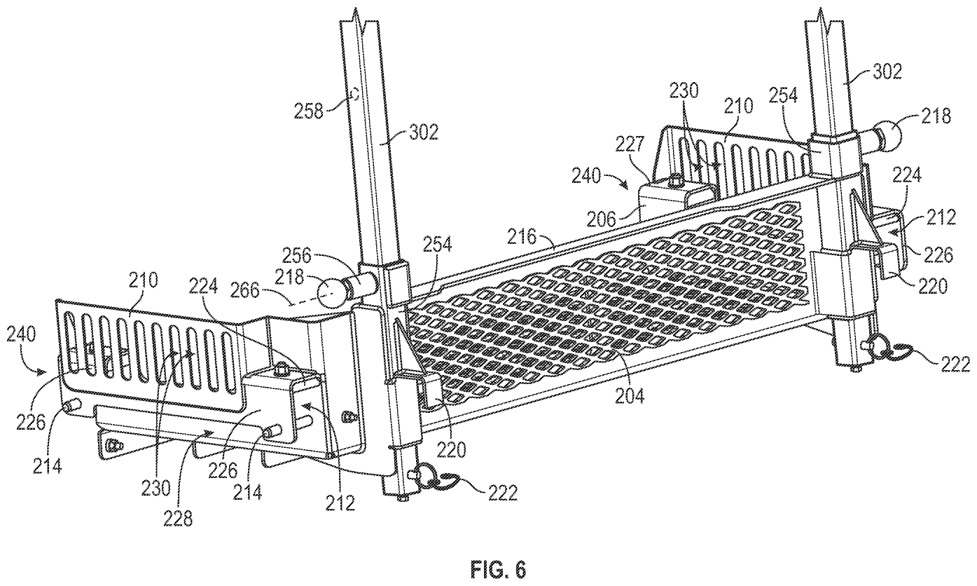

Referring particularly to FIG. 6, the vertical sections 302 include a retention pin 222 at a bottom or end of the vertical sections 302. The retention pins 222 are configured to limit or prevent the hand rail 300 from being removed when changing height of the hand rail 300 (e.g., when the spring release pins 218 are in the unlocked positions). In some embodiments, the vertical sections 302 include multiple openings 258 positioned at different heights so that the hand rail 300 can be transitioned between predetermined heights. In some embodiments, the retention pins 222 are removable so that the hand rail 300 can be completely removed or installed.

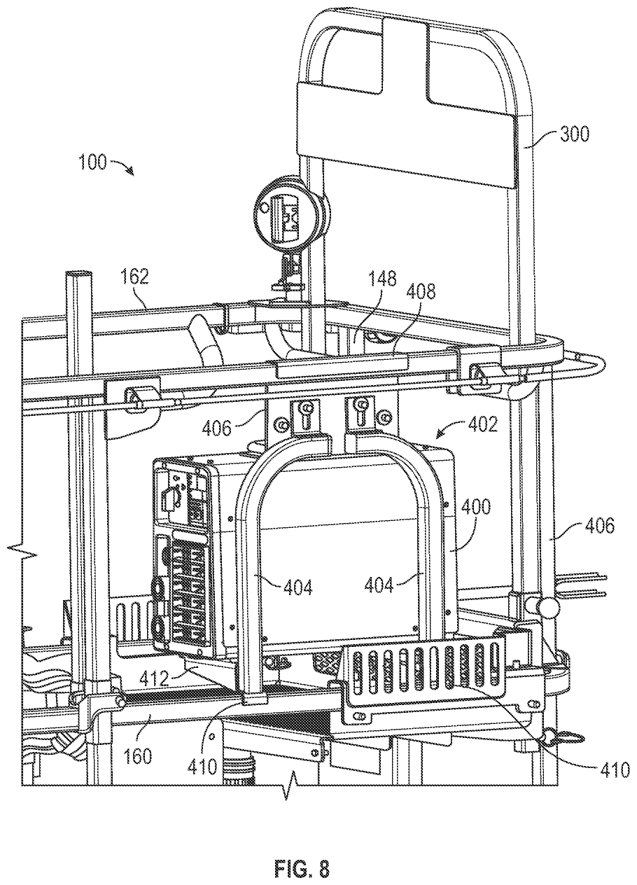

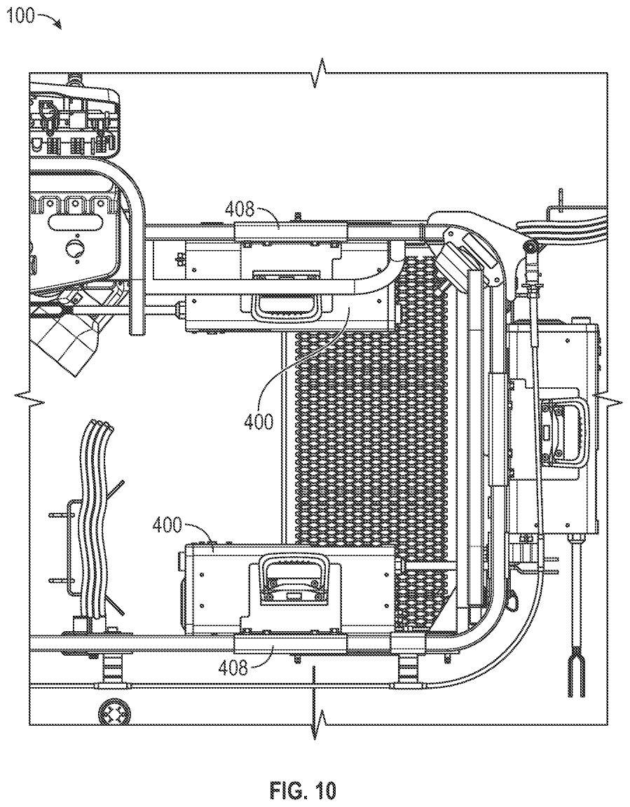

Referring to FIGS. 8-10, the platform 100 is configured to receive, couple with, support, etc., a welder 400 (e.g., a welding unit, a box, equipment, a skywelder, a power unit, platform lighting unit, a platform mesh, sky bumpers, soft touch units, pipe racks, a glass rack, etc.). The welder 400 is configured to couple with the top rail 162 and the middle rail 160. In some embodiments, the welder 400 is configured to couple with the top rail 162 and the middle rail 160 by a support structure 402. The support structure 402 includes a pair of arms 404 that extend between a structural member 406 and the middle rail 160. The arms 404 may have a J or an L shape. In some embodiments, the arms 404 fixedly couple with the structural member 406 at a first end. The arms 404 each include a hook 410 (e.g., a foot) at a second end of the arms 404. The hook 410 is configured to engage or directly contact a top surface, and longitudinal surfaces of the middle rail 160. In some embodiments, the hook 410 extends on opposite sides of the middle rail 160 and over a top of the middle rail 160 to facilitate fixedly coupling the support structure 402 on the platform 100. The structural member 406 extends upwards between the arms 404 and the top rail 162. The structural member 406 includes a hook 408 that is configured to extend around the top rail 162 on three sides of the top rail 162. The hook 408 and the hooks 410 are configured to couple or secure the support structure 402 on the top rail 162 and the middle rail 160 (e.g., on the platform 100).

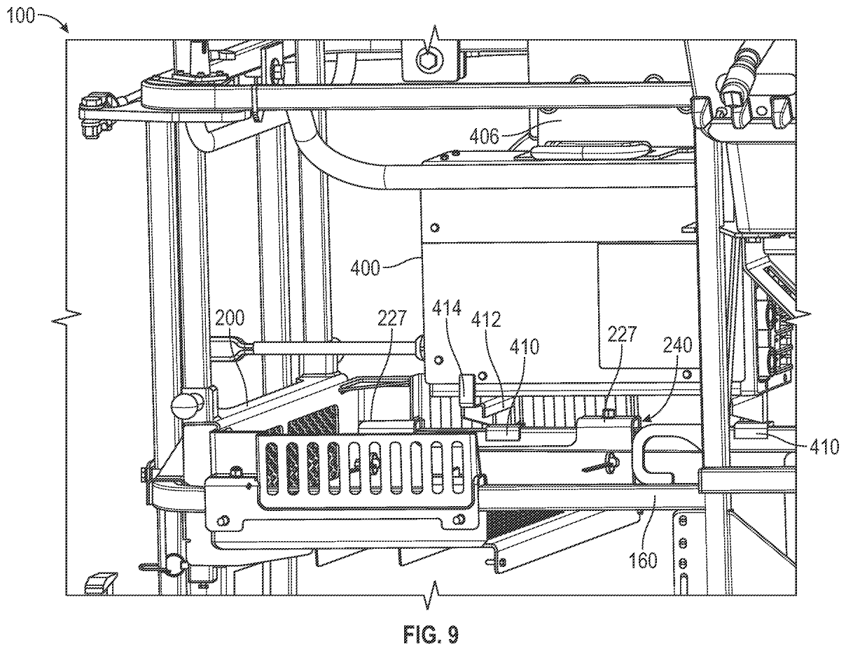

As shown in FIGS. 8-9, at least one of the hooks 410 (e.g., the feet of the support structure 402) are configured to engage, contact, or couple with the middle rail 160 at a position between opposite ends of the side portions 240 of the removable deck 200 (e.g., between the webs 227 at opposite ends of the side portions 240). Advantageously, the side portions 240 of the removable deck 200 expose portions of the middle rails 160 so that the support structure 402 (e.g., one of the hooks 410 of the legs 404) can engage with the middle rails 160.

Referring again to FIGS. 8-10, the support structure 402 also includes beams 412 (e.g., cantilever beams, bars, arms, legs, shelves, elongated members, etc.) that extend from the legs 404 (e.g., proximate the hooks 410 of the legs 404) and provide support for the welder 400. In some embodiments, the welder 400 is configured to rest upon the beams 412. In some embodiments, the beams 412 include hooks 414 (e.g., extending from a free end of the beams 412 opposite the end of the beams 412 that couples with the arms 404) that extend vertically and are configured to facilitate securing the welder 400 on the support structure 402.

### Scissor Lift

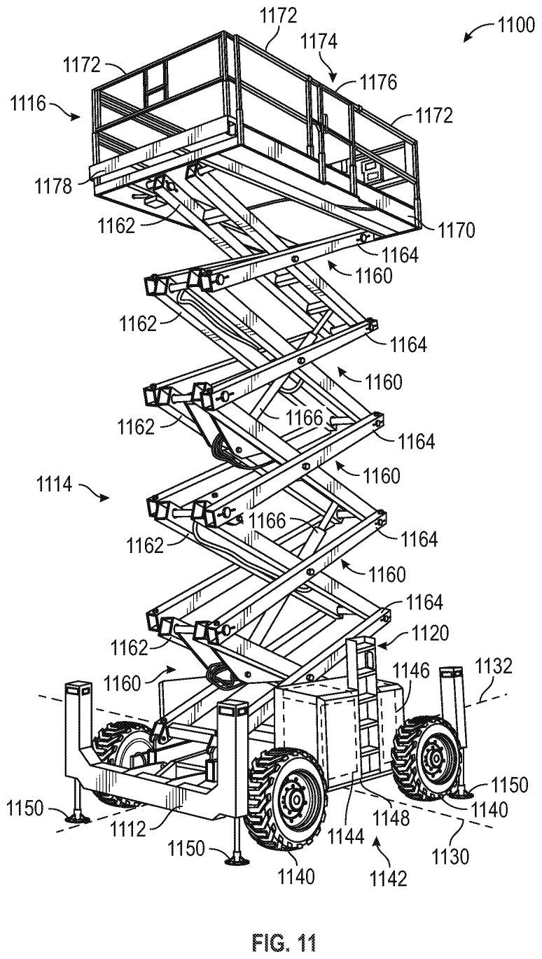

According to the exemplary embodiment shown in FIG. 11, a lift device (e.g., a scissor lift, an aerial work platform, a boom lift, a telehandler, etc.), shown as scissors lift 1100, includes a chassis, shown as frame assembly 1112. A lift device (e.g., a scissor assembly, a boom assembly, etc.), shown as lift assembly 1114, couples the frame assembly 1112 to a platform, shown as platform 1116. The frame assembly 1112 supports the lift assembly 1114 and the platform 1116, both of which are disposed directly above the frame assembly 1112. In use, the lift assembly 1114 extends and retracts to raise and lower the platform 1116 relative to the frame assembly 1112 between a lowered position and a raised position. The scissors lift 1100 includes an access assembly, shown as an access assembly 1120, that is coupled to the frame assembly 1112 and configured to facilitate access to the platform 1116 from the ground by an operator when the platform 1116 is in the lowered position.

Referring again to FIG. 11, the frame assembly 1112 defines a horizontal plane having a lateral axis 1130 and a longitudinal axis 1132. In some embodiments, the frame assembly 1112 is rectangular, defining lateral sides extending parallel to the lateral axis 1130 and longitudinal sides extending parallel to the longitudinal axis 1132. In some embodiments, the frame assembly 1112 is longer in a longitudinal direction than in a lateral direction. In some embodiments, the scissors lift 1100 is configured to be stationary or semi-permanent (e.g., a system that is installed in one location at a work site for the duration of a construction project). In such embodiments, the frame assembly 1112 may be configured to rest directly on the ground and/or the scissors lift 1100 may not provide powered movement across the ground. In other embodiments, the scissors lift 1100 is configured to be moved frequently (e.g., to work on different tasks, to continue the same task in multiple locations, to travel across a job site, etc.). Such embodiments may include systems that provide powered movement across the ground.

Referring to FIG. 11, the scissors lift 1100 is supported by a plurality of tractive assemblies 40, each including a tractive element (e.g., a tire, a track, etc.), that are rotatably coupled to the frame assembly 1112. The tractive assemblies 1140 may be powered or unpowered. As shown in FIG. 11, the tractive assemblies 1140 are configured to provide powered motion in the direction of the longitudinal axis 1132. One or more of the tractive assemblies 1140 may be turnable to steer the scissors lift 1100. In some embodiments, the scissors lift 1100 includes a powertrain system 1142. In some embodiments, the powertrain system 1142 includes a primary driver 1144 (e.g., an engine). A transmission may receive the mechanical energy and provide an output to one or more of the tractive assemblies 1140. In some embodiments, the powertrain system 1142 includes a pump 1146 configured to receive mechanical energy from the primary driver 1144 and output a pressurized flow of hydraulic fluid. The pump 1146 may supply mechanical energy (e.g., through a pressurized flow of hydraulic fluid) to individual motive drivers (e.g., hydraulic motors) configured to facilitate independently driving each of the tractive assemblies 1140. In other embodiments, the powertrain system 1142 includes an energy storage device (e.g., a battery, capacitors, ultra-capacitors, etc.) and/or is electrically coupled to an outside source of electrical energy (e.g., a standard power outlet). In some such embodiments, one or more of the tractive assemblies 1140 include an individual motive driver (e.g., a motor that is electrically coupled to the energy storage device, etc.) configured to facilitate independently driving each of the tractive assemblies 1140. The outside source of electrical energy may charge the energy storage device or power the motive drivers directly. The powertrain system 1142 may additionally or alternatively provide mechanical energy (e.g., using the pump 1146, by supplying electrical energy, etc.) to one or more actuators of the scissors lift 1100 (e.g., the leveling actuators 1150, the lift actuators 1166, etc.). One or more components of the powertrain system 1142 may be housed in an enclosure, shown as housing 1148. The housing 1148 is coupled to the frame assembly 1112 and extends from a side of the scissors lift 1100 (e.g., a left or right side). The housing 1148 may include one or more doors to facilitate access to components of the powertrain system 1142.

In some embodiments, the frame assembly 1112 is coupled to one or more actuators, shown in FIG. 11 as leveling actuators 1150. The scissors lift 1100 includes four leveling actuators 1150, one in each corner of the frame assembly 1112. The leveling actuators 1150 extend and retract vertically between a stored position and a deployed position. In the stored position, the leveling actuators 1150 are raised and do not contact the ground. In the deployed position, the leveling actuators 1150 contact the ground, lifting the frame assembly 1112. The length of each of the leveling actuators 1150 in their respective deployed positions may be varied to adjust the pitch (i.e., rotational position about the lateral axis 1130) and the roll (i.e., rotational position about the longitudinal axis 1132) of the frame assembly 1112. Accordingly, the lengths of the leveling actuators 1150 in their respective deployed positions may be adjusted such that the frame assembly 1112 is leveled with respect to the direction of gravity, even on uneven or sloped terrains. The leveling actuators 1150 may additionally lift the tractive elements of the tractive assemblies 1140 off the ground, preventing inadvertent driving of the scissors lift 1100.

Referring to FIG. 11, the lift assembly 1114 includes a number of subassemblies, shown as scissor layers 1160, each including a first member, shown as inner member 1162, and a second member, shown as outer member 1164. In each scissor layer 1160, the outer member 1164 receives the inner member 1162. The inner member 1162 is pivotally coupled to the outer member 1164 near the centers of both the inner member 1162 and the outer member 1164. Accordingly, inner member 1162 pivots relative to the outer member 1164 about a lateral axis. The scissor layers 1160 are stacked atop one another to form the lift assembly 1114. Each inner member 1162 and each outer member 1164 has a top end and a bottom end. The bottom end of each inner member 1162 is pivotally coupled to the top end of the outer member 1164 immediately below it, and the bottom end of each outer member 1164 is pivotally coupled to the top end of the inner member 1162 immediately below it. Accordingly, each of the scissor layers 1160 are coupled to one another such that movement of one scissor layer 1160 causes a similar movement in all of the other scissor layers 1160. The bottom ends of the inner member 1162 and the outer member 1164 belonging to the lowermost of the scissor layers 1160 are coupled to the frame assembly 1112. The top ends of the inner member 1162 and the outer member 1164 belonging to the uppermost of the scissor layers 1160 are coupled to the platform 1116. The inner members 62 and/or the outer members 64 are slidably coupled to the frame assembly 1112 and the platform 1116 to facilitate the movement of the lift assembly 1114. Scissor layers 1160 may be added to or removed from the lift assembly 1114 to increase or decrease, respectively, the maximum height that the platform 1116 is configured to reach.

One or more actuators (e.g., hydraulic cylinders, pneumatic cylinders, motor-driven leadscrews, etc.), shown as lift actuators 1166, are configured to extend and retract the lift assembly 1114. As shown in FIG. 11, the lift assembly 1114 includes a pair of lift actuators 1166. Lift actuators 1166 are pivotally coupled to an inner member 1162 at one end and pivotally coupled to another inner member 1162 at the opposite end. These inner members 1162 belong to a first scissor layer 1160 and a second scissor layer 1160 that are separated by a third scissor layer 1160. In other embodiments, the lift assembly 1114 includes more or fewer lift actuators 1166 and/or the lift actuators 1166 are otherwise arranged. The lift actuators 1166 are configured to actuate the lift assembly 1114 to selectively reposition the platform 1116 between the lowered position, where the platform 1116 is proximate the frame assembly 1112, and the raised position, where the platform 1116 is at an elevated height. In some embodiments, extension of the lift actuators 1166 moves the platform 1116 vertically upward (extending the lift assembly 1114), and retraction of the linear actuators moves the platform 1116 vertically downward (retracting the lift assembly 1114). In other embodiments, extension of the lift actuators 1166 retracts the lift assembly 1114, and retraction of the lift actuators 1166 extends the lift assembly 1114. In some embodiments, the outer members 1164 are approximately parallel and/or contacting one another when with the lift assembly 1114 in a stored position. The scissors lift 1100 may include various components to drive the lift actuators 1166 (e.g., pumps, valves, compressors, motors, batteries, voltage regulators, etc.).

Referring again to FIG. 11, the platform 1116 includes a support surface, shown as deck 1170, defining a top surface configured to support operators and/or equipment and a bottom surface opposite the top surface. The bottom surface and/or the top surface extend in a substantially horizontal plane. A thickness of the deck 1170 is defined between the top surface and the bottom surface. The bottom surface is coupled to a top end of the lift assembly 1114. In some embodiments, the deck 1170 is rectangular. In some embodiments, the deck 1170 has a footprint that is substantially similar to that of the frame assembly 1112.

Referring again to FIG. 11, a number of railings, shown as hand rails 1172, extend upwards from the deck 1170. The hand rails 1172 extend around an outer perimeter of the deck 1170, partially or fully enclosing a supported area on the top surface of the deck 1170 that is configured to support operators and/or equipment. The hand rails 1172 provide a stable support for the operators to hold and facilitate containing the operators and equipment within the supported area. The hand rails 1172 define one or more openings 1174 through which the operators can access the deck 1170. The opening 1174 may be a space between two hand rails 1172 along the perimeter of the deck 1170, such that the hand rails 1172 do not extend over the opening 1174. Alternatively, the opening 1174 may be defined in a hand rail 1172 such that the hand rail 1172 extends across the top of the opening 1174. In some embodiments, the platform 1116 includes a door 1176 that selectively extends across the opening 1174 to prevent movement through the opening 1174. The door 1176 may rotate (e.g., about a vertical axis, about a horizontal axis, etc.) or translate between a closed position, shown in FIG. 11, and an open position. In the closed position, the door 1176 prevents movement through the opening 1174. In the open position, the door 1176 facilitates movement through the opening 1174.

Referring again to the embodiments of FIG. 11, the platform 1116 further includes one or more platforms, shown as extendable decks 1178, that are received by the deck 1170 and that each define a top surface. The extendable decks 1178 are selectively slidable relative to the deck 1170 between an extended position and a retracted position. In the retracted position, shown in FIG. 11, the extendable decks 1178 are completely or almost completely received by the deck 1170. In the extended position, the extendable decks 1178 project outward (e.g., longitudinally, laterally, etc.) relative to the deck 1170 such that their top surfaces are exposed. With the extendable decks 1178 projected, the top surfaces of the extendable decks 1178 and the top surface of the deck 1170 are all configured to support operators and/or equipment, expanding the supported area. In some embodiments, the extendable decks 1178 include hand rails partially or fully enclose the supported area. The extendable decks 1178 facilitate accessing areas that are spaced outward from the frame assembly 1112.

Referring to FIG. 11, the access assembly 1120 is coupled to a longitudinal side of the frame assembly 1112. As shown in FIG. 11, the access assembly 1120 is a ladder assembly extending along a longitudinal side of the frame assembly 1112. The access assembly 1120 is aligned with the door 1176 such that, when the platform 1116 is in the lowered position, the access assembly 1120 facilitates access to the upper surface of the platform 1116 through the opening 1174.

### Removable Deck for Scissor Lift

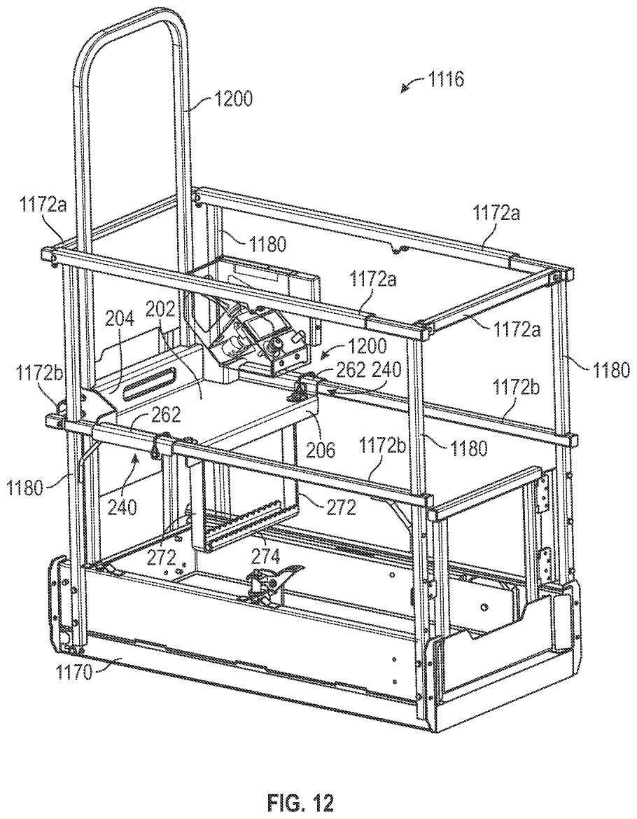

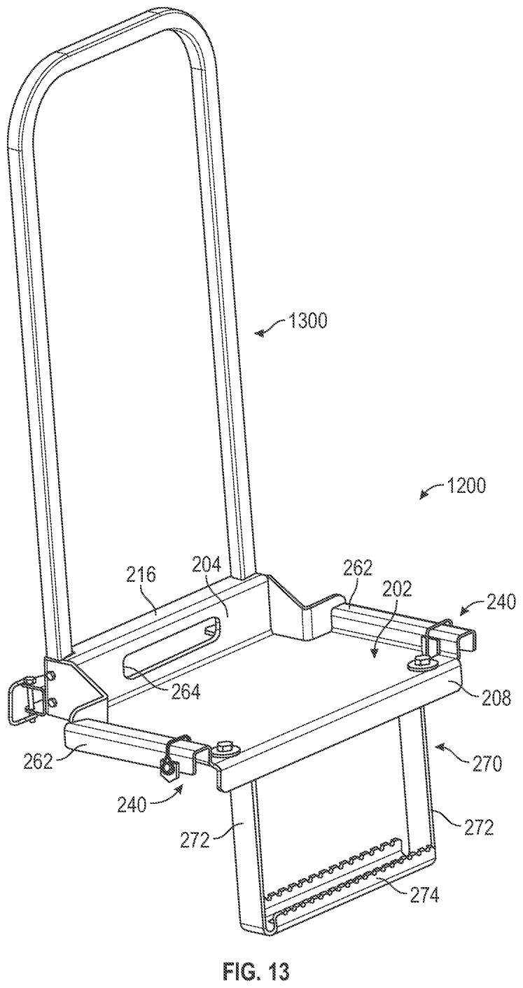

Referring to FIGS. 12 and 13, the platform 1116 includes a removable deck 1200. The removable deck 1200 may be the same as or similar to the removable deck 200 as described in greater detail above with reference to FIGS. 3-10. The platform 1116 may have a rectangular shape and includes vertical rails 1180 positioned at four corners of the platform 1116. The vertical rails 1180 extend from the deck 1170. The platform 1116 also includes top rails 1172a that are positioned at a top of the vertical rails 1180, and middle rails 1172b that are positioned between the top rails 1172a and the deck 1170. The middle rails 1172b may be similar to the middle rails 160. In some embodiments, the removable deck 1200 has a load bearing capacity of 250 lbs.

As shown in FIGS. 12-13, the removable deck 1200 can be the same as or similar to the removable deck 200. The removable deck 1200 includes the medial portion 202, and the side portions 240. The side portions 240 include channels 262 (e.g., including the wear pads 224 positioned within the channels 262) that extend along sides of the medial portion 202. The removable deck 1200 also includes the back portion 204 having the edge 216 and an opening 264 (e.g., a slot) formed in the back portion 204. The channels 262 can be configured to couple the removable deck 1200 on the middle rails 1172b similar to the coupling described between the removable deck 200 with the middle rails 160 as described in greater detail above with reference to FIGS. 3-10.

As shown in FIG. 13, the removable deck 1200 includes a pair of beams 272 (e.g., elongated members, bars, shafts, rods, etc.) that extend in a downwards direction proximate the weldment 208 of the medial portion 202. An elongated member 274 extends between the beams 272 at ends of the beams 272. In some embodiments, the beams 272 and the elongated member 274 are suspended from a bottom of the medial portion 202.

Referring still to FIG. 13, the removable deck 1200 includes a rail 1300 that extends from the back portion 204 of the removable deck 1200. In some embodiments, the rail 1300 has a U-shape. In some embodiments, the rail 1300 is fixedly coupled with the removable deck 1200 (e.g., fixedly coupled with the back portion 204). In some embodiments, the rail 1300 is coupled with the rear portion 204 similarly as described above with reference to FIGS. 5-7 so that the rail 1300 can be adjusted in height or position relative to the rear portion 204 of the removable deck 1200.

Advantageously, the removable deck 200 and/or the removable deck 1200 described herein may provide a support surface for operators to store equipment. In some embodiments, the removable deck 200 and/or the removable deck 1200 provide exposure to rails so that attachments (e.g., welding units, power units, etc.) can be mounted on the rails. The removable deck 200 and the removable deck 1200 also limit translation relative to the rails by limiting one or more degrees of freedom to thereby provide a robust deck.

### Modified Removable Deck

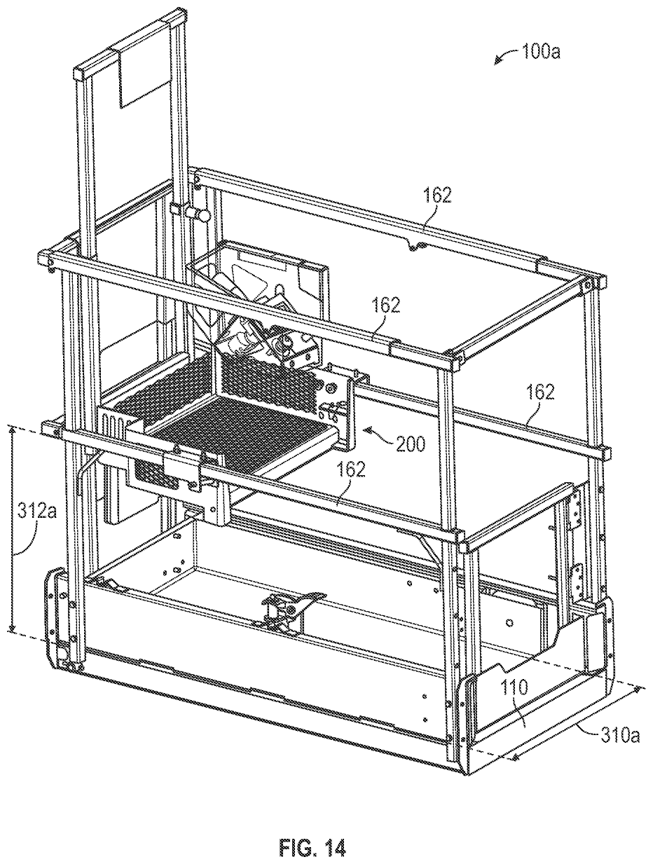

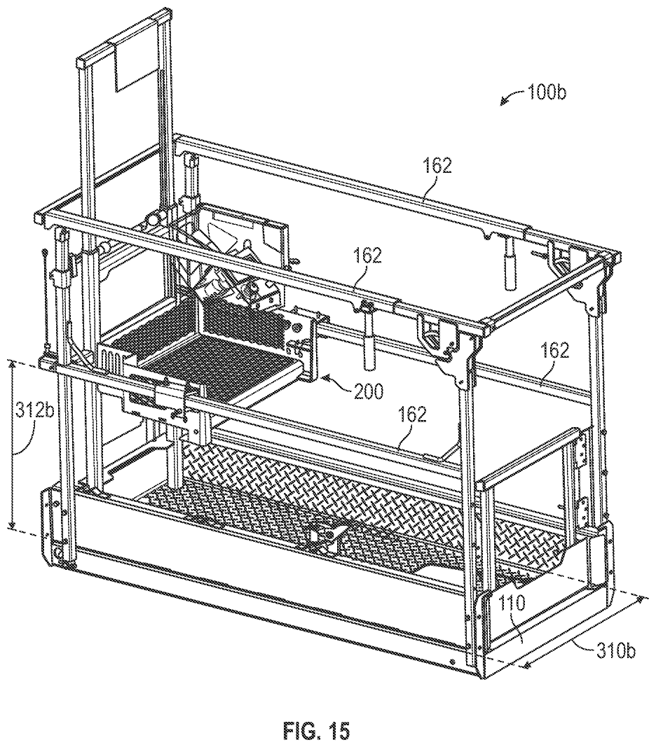

Referring to FIGS. 14 and 15, the deck 200 may be installed on various platforms 100 of a variety of scissors lifts or lift devices (e.g., different models, different configurations, different sizes, etc.), according to some embodiments. For example, the deck 200 may be installed on a platform 100a of a scissors lift with a width 310a of substantially 30 inches (e.g., a 30 inch wide platform). The platform 100a may have a rail height 312a of substantially 43.3 inches (e.g., 1.1 meters). The rail height 312a may be a measurement of the middle rails 162 relative to the base 110. The platform 100a may be a steel platform with steel telescoping mid-rails, and a fixed rail design. The platform 100b may have a width 310b of substantially 32 inches (e.g., a 32 inch wide platform) with a rail height 312b of substantially 43.3 inches (e.g., 1.1 meters). The rail height 312b may be a measurement of the middle rails 162 relative to the base 110. The platform 100a and the platform 100b may be for scissors lift models that comply with ANSI 92.2. Advantageously, the deck 200 may be a common deck assembly that integrates into current production and legacy platforms 100 (e.g., different models) having different handrail configurations (e.g., different handrail widths 310).

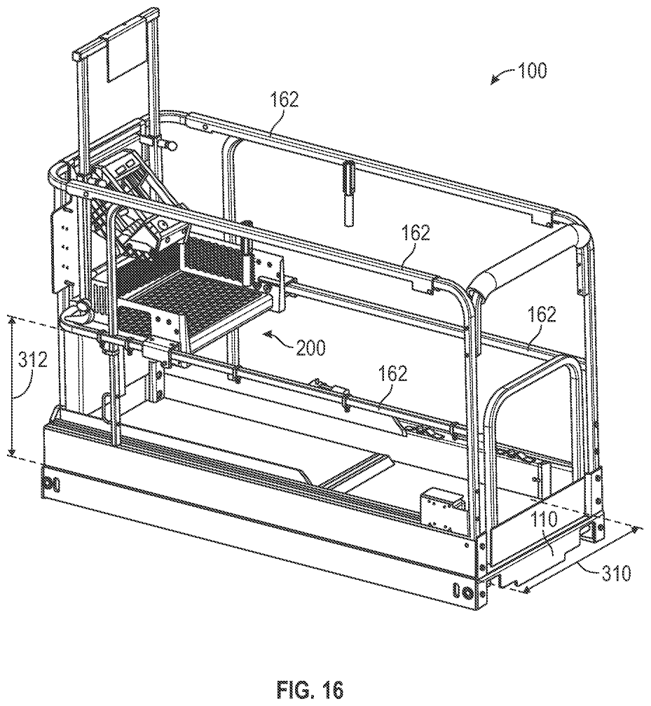

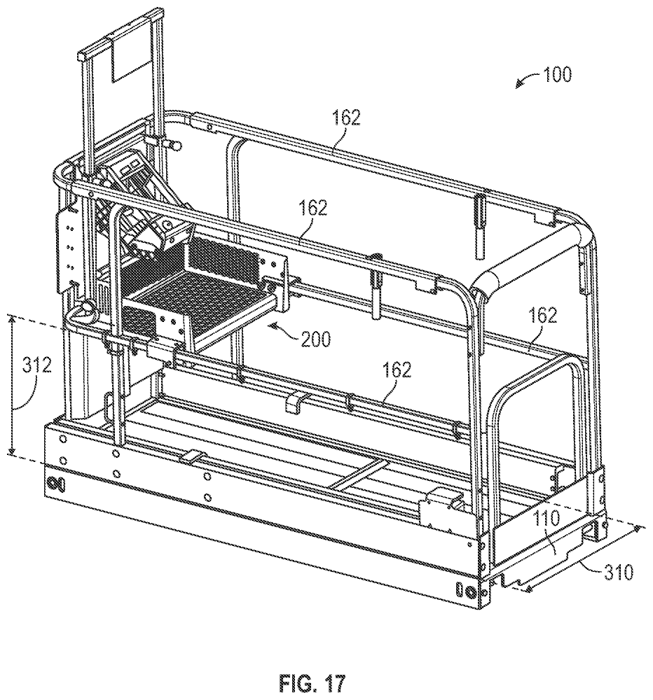

Referring to FIGS. 16 and 17, the deck 200 may be similarly installed on platforms 100 manufactured from aluminum, steel, fiberglass, etc., that are 30 inches wide (e.g., have a width 310 of substantially 30 inches) and have a rail height 312 of substantially 39.37 inches (e.g., 1.0 meter) measured from the base 110 to the middle rails 162. The platforms 100 shown in FIGS. 16 and 17 may be for scissors lifts that comply with ANSI 92.5.

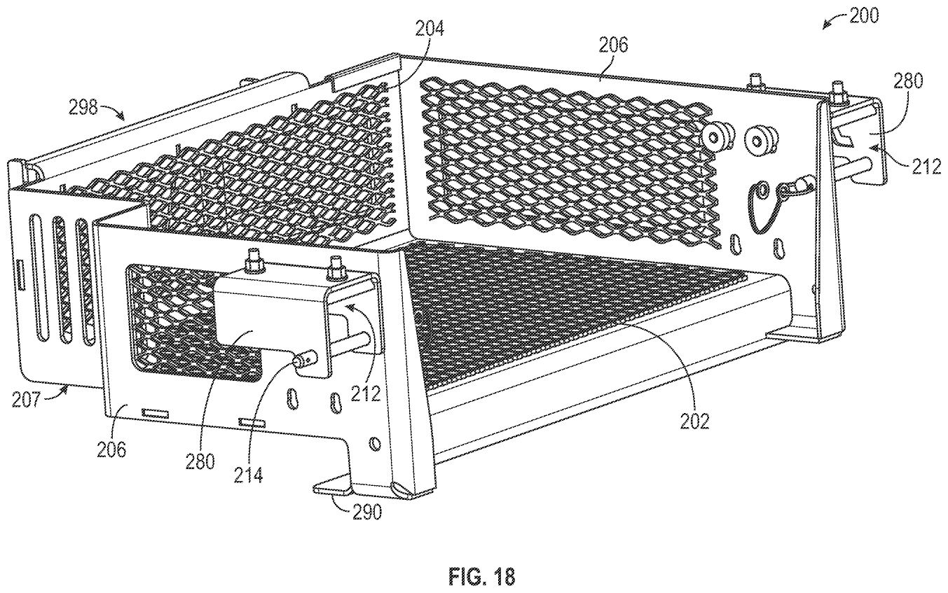

Referring to FIG. 18, the deck 200 may include a pair of hooks 280 disposed on outer surfaces of the inner walls 206 positioned proximate an upper edge or surface of the inner walls 206. In some embodiments, one of the inner walls 206 includes a notch, indented corner, etc., shown as corner 207 that extends inwards in order to avoid interference with a vertical rail of the platform 100. The corner 207 (e.g., a shoulder) may define a first wall or surface that is perpendicular to an adjacent portion of the inner wall 206 and parallel with the rear wall 204 (e.g., forms a corner with the inner wall 206), and a second wall or surface that is perpendicular to the rear wall 204 and forms a corner with the rear wall 204. The deck 200 may include a common mounting interface 298 (e.g., a platform coupler, a platform interface, a rail interface, a rail coupling portion, etc.) for rail designs of multiple different platforms 100 positioned on a rear or exterior side of the back portion 204. The deck 200 may provide a common or universal 19.5 inch deck or surface height for various models of platforms 100 (e.g., 19.5 inches from the base 110 to the medial portion 202). The deck 200 may weigh substantially 14 pounds. The deck 200 may include a double bent front edge, shown as hook 290 for stowing or storing the deck 200 when not in use. The hook 290 generally includes a first portion that extends perpendicularly (e.g., in a downwards direction) from an open edge of the medial portion 202) and a second portion that extends perpendicularly to the first portion towards the back portion 204. In some embodiments, the hooks 280 are adjustable (e.g., in a direction parallel with the rear portion 204) in order to accommodate different platforms 100 having different widths of mid rails. The hooks 280 may be adjustable mid-rail feet that provide attachment points to maintain a uniform or same deck height (e.g., 19.5 inches) across different models of platforms 100.

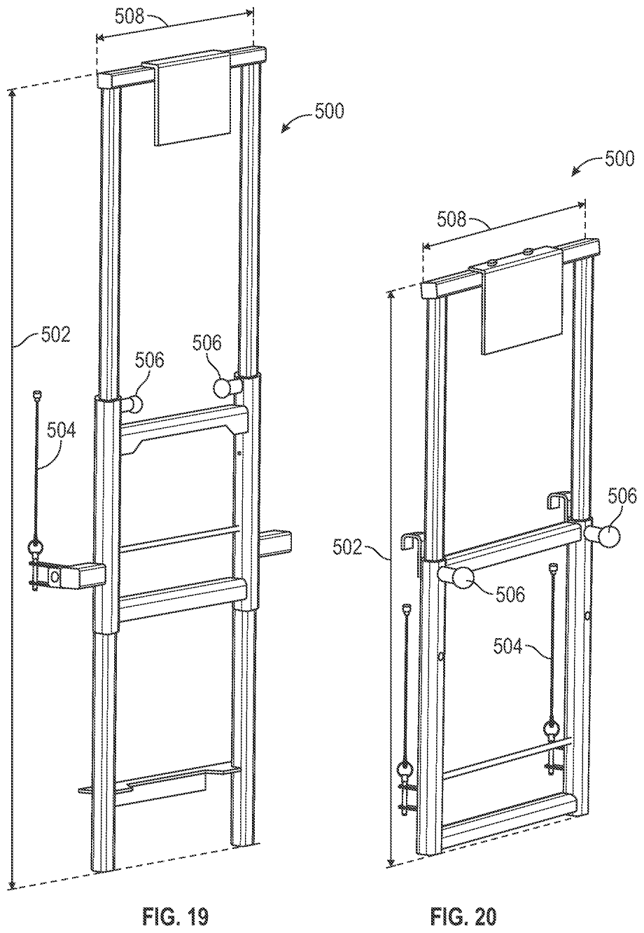

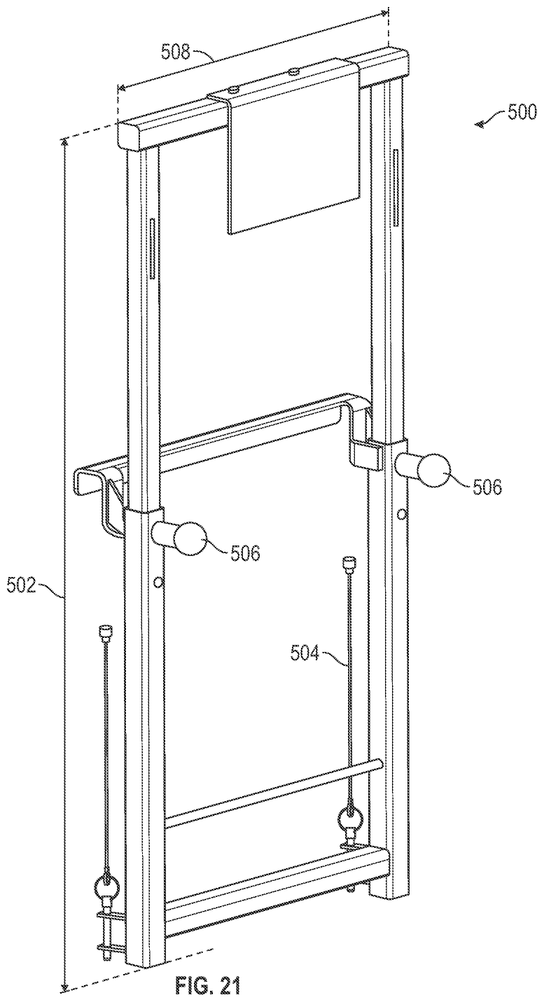

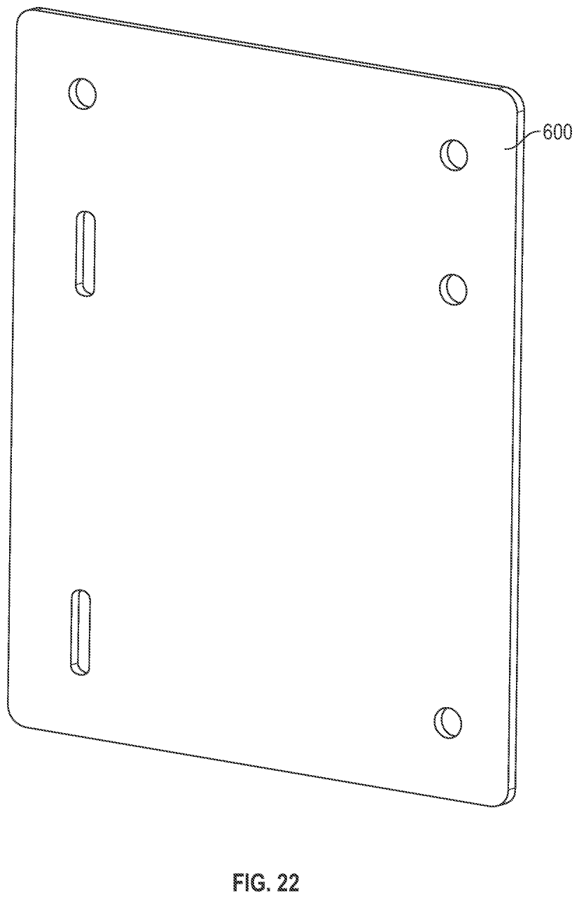

Referring to FIGS. 19-21, the deck 200 may be coupled with a rail assembly 500 that is the same as or similar to the hand rail 300 or the hand rail 1300. The rail assembly 500 may include multiple telescoping members or rails that can be extended relative to each other to adjust an overall height of the rail assembly 500. FIG. 19 illustrates a first rail assembly 500 for a first model of lift device, scissors lift, or platform 100 having a height 502 of substantially 43.3 inches (e.g., 1.1 meters) when fully extended, while FIG. 20 illustrates a second rail assembly 500 for a different model of lift device, scissors lift, or platform 100 having height 502 of 43.3 inches (e.g., 1.1 meter) when fully extended. FIG. 21 illustrates a third rail assembly 500 having height 502 of substantially 39.37 inches (e.g., 1.0 meter) when fully extended for a different model of lift device, scissors lift, or platform 100. The deck 200 may be usable or coupleable with any of the rail assemblies 500 shown in FIGS. 19-21. In some embodiments, the rail assemblies 500 have a modular design and can be installed on the platform 100 without requiring tools. In some embodiments, an upper portion, member, or rail of the rail assemblies 500 is flush with the top rails 162 of the platform 100 when fully retracted. In some embodiments, the rail assemblies 500 includes features to limit over extension of the rail assemblies 500 (e.g., cables 504 to limit over extension). The rail assemblies 500 may have pins 506 configured to lock the rail assemblies 500 in the fully extended position, the fully retracted position, or an intermediate position. The rail assemblies 500 may include a box relocation bracket 600 that functions as a decal billboard, as shown in FIG. 22. The rail assemblies 500 may have a width 508 of substantially 18 inches in order to fit withing a 24 inch by 24 inch ceiling tile.

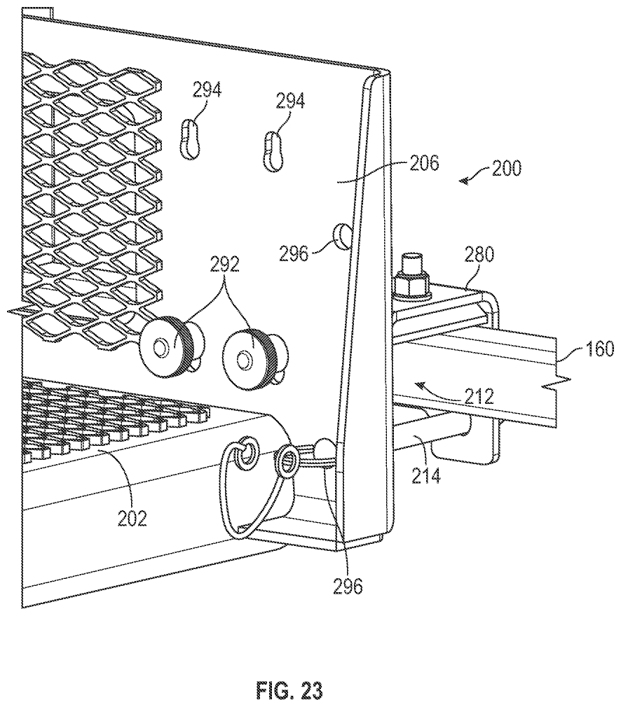

Referring to FIG. 23, the hooks 280 may be repositionable between a lower position and an upper position along the inner walls 206 of the deck 200. In some embodiments, the inner walls 206 define openings 294 (e.g., a first pair of openings at an upwards position along the inner walls 206 and a second pair of openings at a lower position along the inner walls 206) that are configured to receive fasteners 292 that extend through the inner walls 206 and couple the hooks 280 with the inner walls 206. In some embodiments, the fasteners 292 are thumb screws in order to facilitate easy loosening and tightening of the hooks 280 to transition the hooks 280 between the upper and lower positions. FIG. 23 illustrates the hooks 280 in the lower position with the fasteners 292 extending through the second pair of openings 294 and coupling the hooks 280 with the inner walls 206 at the lower position. The hooks 280 can be adjusted between the upper position and the lower position such that when the hooks 280 are hooked into the middle rails 160 of different platforms 100 (e.g., different models of platforms having middle rails 160 at different heights), a same height between the support surface 112 of the platform 100 and the medial portion 202 of the deck 200 (e.g., the support surface of the deck 200) is achieved. In some embodiments, the hooks 280 are adjustable between the upper position and the lower position in order to maintain a consistent height of the deck 200 (e.g., at 19.5 inches relative to the support surface 112) between different models of platforms 100 and lift devices (e.g., current and legacy models of platforms 100 or lift devices).

Referring still to FIG. 23, the inner walls 206 may include openings 296 (e.g., apertures, through holes, bores, etc.) that are configured to receive the pin 214 for coupling the hooks 280 with the middle rails 160 (e.g., to limit removal of the deck 200 from the middle rails 160). In some embodiments, the openings 296 are disposed proximate the openings 294. The openings 294 may include a first opening positioned proximate the first openings 294 for receiving the pin 214 when the hooks 280 are transitioned to the upper position, and a second opening positioned proximate the second openings 294 for receiving the pin 214 when the hooks 280 are transitioned to the lower position.

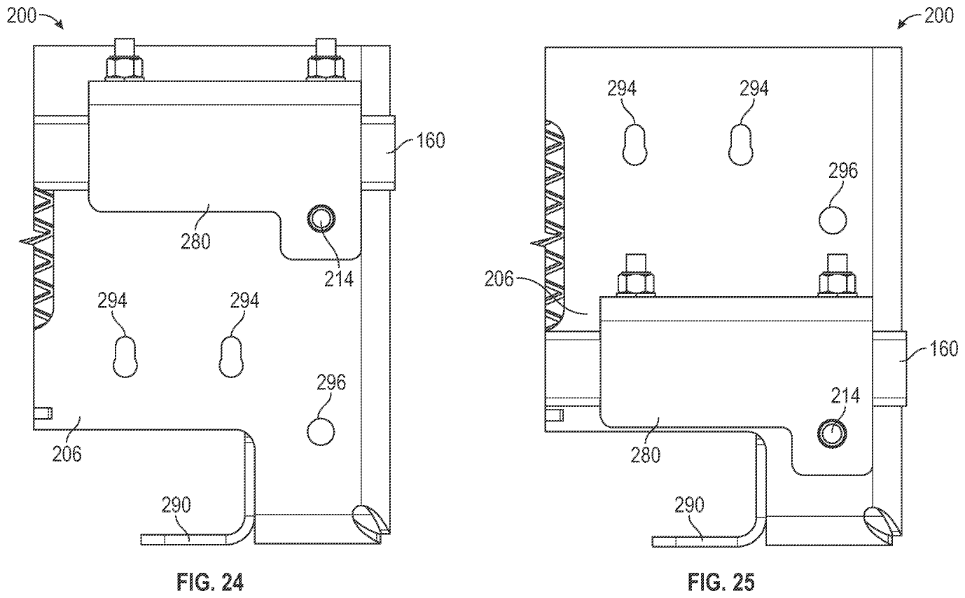

Referring to FIGS. 24 and 25, the deck 200 is shown with the hooks 280 in the upper position and the lower position, respectively, according to some embodiments. When the hooks 280 are installed in the upper position, the fasteners 292 extend through the upper pair of openings 294 in order to couple the hooks 280 in the upper position, and the pin 214 is inserted through the upper opening 296 (shown in FIG. 24). Similarly, when the hooks 280 are installed in the lower position, the fasteners 292 extend through the lower pair of openings 294 in order to couple the hooks 280 in the lower position, and the pin 214 is inserted through the lower openings 296 (shown in FIG. 25).

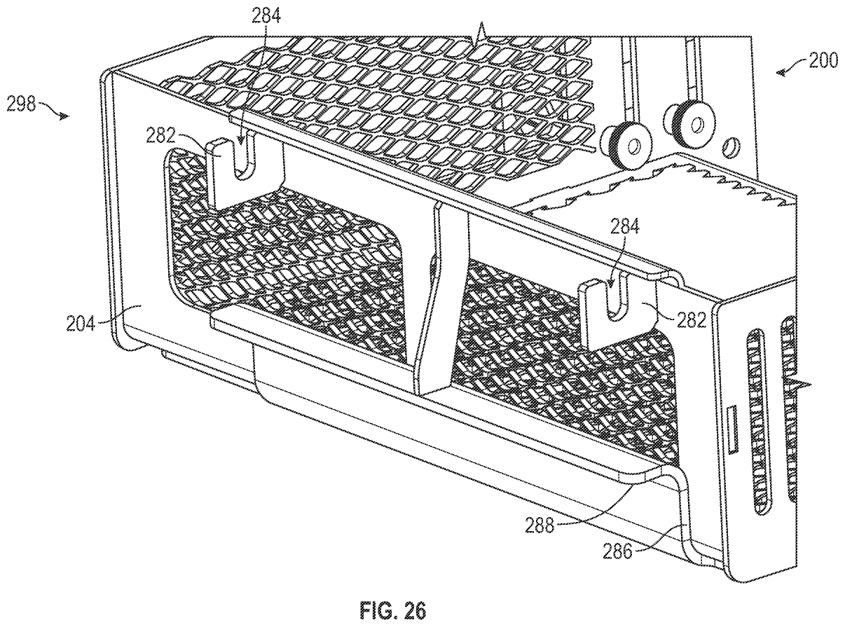

Referring to FIG. 26, the deck 200 may include geometry or structure for coupling the deck 200 with the platform 100, according to some embodiments. The mounting interface 298 of the deck 200 is positioned on an exterior surface of the back portion 204 and includes a pair of hooks 282 (e.g., tabs, structural members, protrusions, etc.) that define open ended slots 284 (e.g., slots, receiving portions, etc.). In some embodiments, the hooks 282 extend from the exterior, rear, or outer surface of the back portion 204 and are spaced apart along the back portion 204 (e.g., proximate the transition between the back portion 204 and the inner walls 206). In some embodiments, the open ended slots 284 include an open end that faces upwards. In some embodiments, the hooks 282 are positioned at a substantially top or upper portion of the back portion 204. In some embodiments, the interface 298 for coupling the deck 200 with the platform 100 also includes a structural member 286 protruding from a bottom of the back portion 204 in an upwards and rearwards direction along the back portion 204. In some embodiments, the structural member 286 has an S-shape or a curved shape and protrudes outwards from the back portion 204. The structural member 286 may extend lengthwise along the back portion 204. In some embodiments, the structural member 286 defines an engagement surface 288 configured to abut or contact a corresponding portion, surface, or member of the platform 100 or the rail assemblies 500 in order to facilitate coupling the deck 200 with the platform 100.

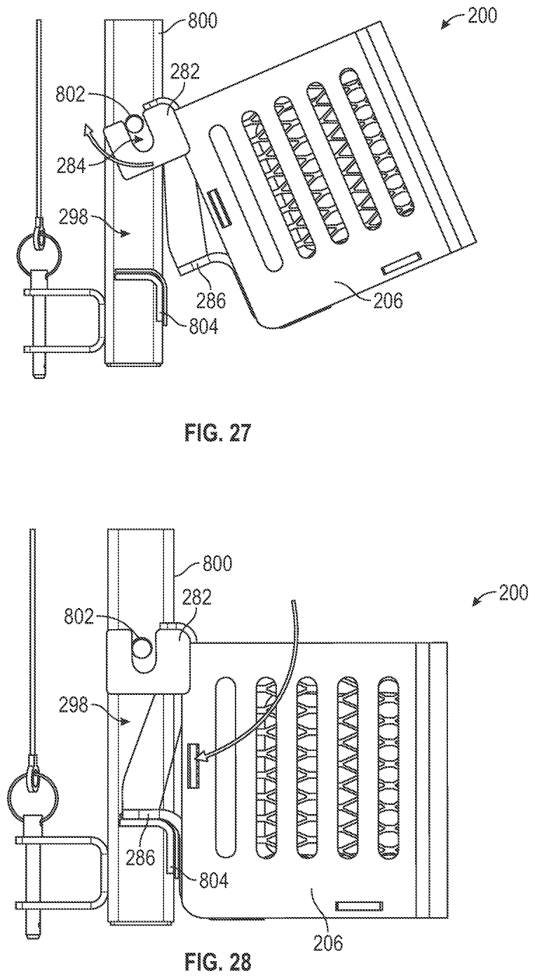

Referring to FIGS. 27 and 28, the deck 200 is shown in various positions during installation onto the platform 100 (e.g., onto the rail assembly 500) via the common mounting interface 298, according to some embodiments. The deck 200 may be installed onto the platform 100 by aligning the open ended slots 284 with pins 802 that extend laterally outwards from or between vertical rails 800 of the platform 100 or the rail assembly 500 with the deck 200 at a first orientation (shown in FIG. 27) and moving the deck 200 such that the pins 802 (e.g., a bar, a beam, an elongated member, a cylindrical member) are received within the open ended slots 284. Once the pins 802 are received within the open ended slots 284, the deck 200 may be rotated about the pins 802 towards the vertical rails 800 such that the structural member 286 (e.g., the engagement surface 288) contacts or abuts a corresponding structural portion 804 of the platform 100 or the rail assembly 500 (e.g., a member that extends between the vertical rails 800, a corner, a step, a shoulder, etc.). Rotation of the deck 200 from the orientation shown in FIG. 27 to the orientation shown in FIG. 28 also results in the middle rails 160 being received within the hooks 280. Once the deck 200 has been rotated to the orientation shown in FIG. 28, the pins 214 may be inserted through the openings 296 and corresponding openings in the hooks 280 in order to finish installing the deck 200 on the platform 100.

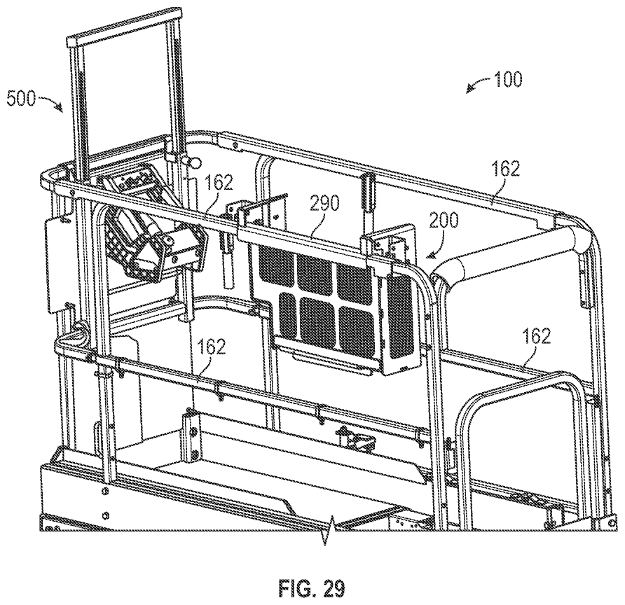

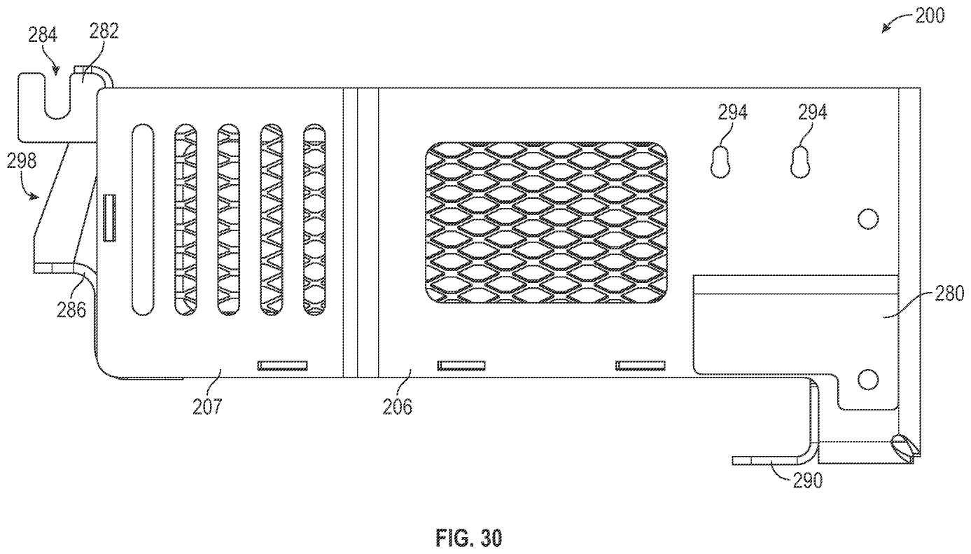

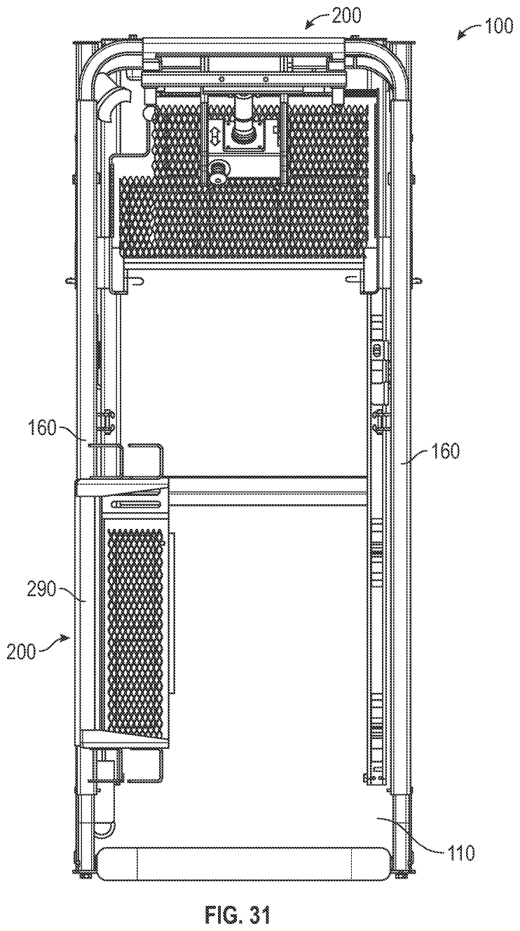

Referring to FIGS. 29-31, the deck 200 includes the hook 290 that extends downwards from an edge of the medial portion 202 at an open end of the deck 200, according to some embodiments. In some embodiments, the hook 290 facilitates temporarily coupling or storing the deck 200 onto the top rail 162 of the platform 100 as shown in FIGS. 29 and 30, or alternatively on the middle rails 160. Advantageously, the deck 200 may be stowed by hanging upon the rails 160 or the rails 162 in order to free up deck space of the platform 100.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device platforms and decks as shown in the various exemplary embodiments are illustrative only. Additionally, any element disclosed in one embodiment may be incorporated or utilized with any other embodiment disclosed herein. For example, the spring release pin 218 shown in FIG. 6 may be incorporated in the removable deck 1200 of the exemplary embodiment shown in at least FIG. 13. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A deck for a lift device, the deck comprising:
a floor defining a surface;
a pair of side portions positioned on opposite sides of the floor, each of the pair of side portions configured to define a channel configured to receive a middle rail of a platform of the lift device;
a plurality of wear pads, wherein at least one wear pad is positioned within each of the channels and abuts a top of the middle rail;
a plurality of pins removably inserted into openings of the side portions, the plurality of pins configured to extend past a bottom surface of the middle rail to limit removal of the deck from the middle rail;
a hand rail extending from a rear portion of the deck.

2. The deck of claim 1, wherein the hand rail comprises a pair of vertical members, the pair of vertical members received within tubular members of the rear portion of the deck, wherein the hand rail is adjustable between different heights relative to the tubular members.

3. The deck of claim 2, further comprising a pin, the pin transitionable between an unlocked position so that the hand rail is translatable relative to the tubular members and a locked position so that the hand rail is limited in translation relative to the tubular members, wherein in the locked position, the pin extend through openings of the tubular member and an opening of a vertical member of the hand rail.

4. The deck of claim 1, wherein the side portions are configured to expose a top surface of a portion of the middle rail, and portions of side surfaces of the middle rail such that a hook of a welding unit can couple with the middle rail along the portion of the middle rail that is exposed.

5. The deck of claim 1, further comprising a pair of hooks extending from a back of the rear portion, the pair of hooks configured to couple with a portion of the middle rail to limit translation of the deck along middle rails of the lift device in a direction of the channels.

6. The deck of claim 1, wherein the deck is configured to support at least 250 pounds.

7. A deck for a lift device, the deck comprising:
a floor defining a surface;
a pair of inner walls positioned on opposite sides of the floor;
a rear wall positioned extending between the pair of inner walls on a rear end of the floor; and
a pair of hooks extending from exterior surfaces of the pair of inner walls, the pair of hooks configured to couple with middle rails of a platform of the lift device on opposite sides of the platform, wherein the pair of hooks are adjustable between an upper position along the pair of inner walls and a lower position along the pair of inner walls in order to accommodate different models of lift devices to maintain a consistent height between a support surface of the platform and the floor of the deck.

8. The deck of claim 7, wherein the pair of hooks are adjustable between the upper position and the lower position to accommodate platform assemblies of lift devices that have different rail heights.

9. The deck of claim 7, wherein one of the inner walls comprises an inwards corner formed between the one of the inner walls and the rear wall to provide space for vertical rails of the platform of the lift device.

10. The deck of claim 7, wherein the deck comprises an open end opposite the rear wall between the pair of inner walls, the deck further comprising a double-bent hook along an edge of the floor at the open end, the double-bent hook comprising a first section extending downwards from the edge of the floor, and a second section extending substantially parallel with the floor in a direction beneath the floor towards the rear wall.

11. The deck of claim 10, wherein the double-bent hook is sized to receive a rail of the platform of the lift device, the double-bent hook configured to allow storage of the deck by hanging the deck on the rail of the platform.

12. The deck of claim 7, wherein the deck comprises a platform interface on a rear of the rear wall, the platform interface configured to removably couple the deck with rails of the platform of the lift device.

13. The deck of claim 12, wherein the platform interface comprises a pair of hooks at an upper edge of the rear wall, the pair of hooks disposed a distance apart along the rear wall and defining slots having an open end that faces upwards, wherein the hooks are configured to receive a bar of the platform through the open end to removably couple the deck with the platform.

14. The deck of claim 13, wherein the platform interface further comprises a curved member that protrudes from a bottom portion of the rear wall, the curved member configured to be rotated into engagement with a horizontal rail as the bar of the platform is inserted into the slots of the hooks and rotated downwards.

15. A lift device comprising:
a base assembly;
a lift assembly coupled with the base assembly; and
a platform coupled with the lift assembly, the platform comprising:
a base;
a plurality of rails; and
a removable deck comprising:
a floor defining a surface;
a pair of inner walls positioned on opposite sides of the floor;
a rear wall positioned extending between the pair of inner walls on a rear end of the floor; and
a pair of hooks extending from exterior surfaces of the pair of inner walls, the pair of hooks configured to couple with middle rails of the platform of the lift device on opposite sides of the platform, wherein the pair of hooks are adjustable between an upper position along the pair of inner walls and a lower position along the pair of inner walls in order to accommodate different models of lift devices to maintain a consistent height between a support surface of the platform and the floor of the removable deck.

16. The lift device of claim 15, wherein the pair of hooks are adjustable between the upper position and the lower position to accommodate platforms of lift devices that have different rail heights.

17. The lift device of claim 15, wherein one of the inner walls comprises an inwards corner formed between the one of the inner walls and the rear wall to provide space for vertical rails of the platform of the lift device.

18. The lift device of claim 15, wherein the removable deck comprises an open end opposite the rear wall between the pair of inner walls, the removable deck further comprising a double-bent hook along an edge of the floor at the open end, the double-bent hook comprising a first section extending downwards from the edge of the floor, and a second section extending substantially parallel with the floor in a direction beneath the floor towards the rear wall.

19. The lift device of claim 18, wherein the double-bent hook is sized to receive a rail of the platform of the lift device, the double-bent hook configured to allow storage of the removable deck by hanging the removable deck on the rail of the platform.

20. The lift device of claim 15, wherein the removable deck comprises a platform interface on a rear of the rear wall, the platform interface configured to removably couple the removable deck with rails of the platform of the lift device and comprising:
a pair of hooks at an upper edge of the rear wall, the pair of hooks disposed a distance apart along the rear wall and defining slots having an open end that faces upwards, wherein the hooks are configured to receive a bar of the platform through the open end to removably couple the removable deck with the platform; and
a curved member that protrudes from a bottom portion of the rear wall, the curved member configured to be rotated into engagement with a horizontal rail as the bar of the platform is inserted into the slots of the hooks and rotated downwards.
